(19) United States
(12) Patent Application Publication
(10) Pub. No.: US 2013/0137869 A1
(43) Pub. Date: May 30, 2013

(54) LUMINOPHORES

(71) Applicants: Duncan W. Bruce, Heslington (GB); Amedeo Santoro, Naples (IT); Anton Mikhailovich Prokhorov, Ekaterinburg (RU)

(72) Inventors: Duncan W. Bruce, Heslington (GB); Amedeo Santoro, Naples (IT); Anton Mikhailovich Prokhorov, Ekaterinburg (RU)

(73) Assignee: UNIVERSITY OF YORK, Heslington, York (UK)

(21) Appl. No.: 13/634,525

(22) PCT Filed: Mar. 11, 2011
(86) PCT No.: PCT/GB2011/000356

§ 371 Date: Feb. 15, 2013

(30) Foreign Application Priority Data
Mar. 13, 2010 (GB) 1004151.5

(51) Int. Cl. C09K 11/06; C07F 15/00

(52) U.S. Cl. CPC C09K 11/06
USPC 546/4; 546/339

(57) ABSTRACT

There is described a non-planar iridium-ligand complex with accessible triplet states and a molecular structure that confers liquid-crystal like properties.

### FIELD OF THE INVENTION

The present invention relates to novel metal complexes with application as the emissive component in organic light emitting diodes, methods of their preparation and their use. More particularly, the invention relates to novel liquid crystals which are also light emitting materials. Thus, the invention also relates to materials comprising such liquid crystals and the use of such materials in, for example, display devices and light sources.

### BACKGROUND TO THE INVENTION

So-called Organic Light-Emitting Diodes (OLEDs) have been the focus of substantial recent attention. OLEDs are widely used in a new generation of low-power, flat-panel (and flexible) displays and are being examined for their use as lighting sources. Among the advantages offered by OLEDs is the possibility for preparation of very flexible displays and lighting sources in novel formats such as conformable panels or coatings for textiles and also the fact that backlighting is not required, so reducing energy consumption.

Whilst much of the effort has been directed towards purely organic systems (particularly in relation to light-emitting polymers), more recently metal-organic systems employing, in particular, third-row transition elements have attracted interest for use in OLED displays. The reason for this lies in the short lifetime of the triplet excited states which are produced when charge is injected into the device. Triplet states of organic materials which are produced in OLED devices are typically long-lived as such emission is a spin-forbidden process. Useful emission is therefore from only one (singlet) of four (singlet plus three triplet) excited states produced. However, the presence of a heavy transition element facilitates efficient spin-orbit coupling, shortening the lifetime of the triplet states and allowing emission from all four excited states produced. In functional terms, this means that OLEDS fabricated from metal complexes could in principle emit up to four times as much light as conventional OLEDs.

Known metal-organic luminophores that emit from triplet states are based on, for example, octahedral complexes of iridium (III) containing two C,N chelates.

Furthermore, in general, existing OLED materials are vacuum deposited or spin coated as layers into devices and as such, are present in an amorphous state, i.e. having no long range structural order. By contrast, liquid crystals have long range structural order, existing in so-called mesophases. An attractive and central feature of liquid crystal mesophases is that the organisation of the molecules therein results in attendant anisotropy of the physical properties. It is because of these anisotropic properties that liquid crystals (and to some extent “liquid crystal like” materials) are versatile and responsive materials, which form the basis of the current flat-panel display industry and are the dominant technology in the market place.

Although metal complex OLED displays are likely to be energy efficient when compared to existing technology, incorporating long-range order and anisotropic properties into molecules used to make metal-organic OLED displays may make a significant further increase in their energy efficiency.

An attractive prospect, therefore, is the combination of liquid crystal properties and light-emitting properties in a single compound. For example, emission from aligned preparations of liquid crystals would lead to polarised emission, whereas, materials capable of forming columnar phases would lead to enhanced carrier mobilities compared to amorphous materials, reducing the amount of electricity needed to power a display.

These properties can be used to improve the quality of the display or light source and to reduce the power needed for the display to work, thus extending the battery life of a portable device such as a mobile phone or a laptop computer. Other advantages of incorporating liquid crystalline properties into a metal-organic OLED display may be envisaged.

We have now surprisingly found a group of novel non-planar organo-iridium complexes which possess the property of being phosphorescent and, in some cases, are liquid crystals or are “liquid crystal like” in which the luminescence properties in the mesophase can be controlled to be quite different from those of the amorphous material.

### SUMMARY OF THE INVENTION

The present invention is based on the discovery of novel materials which are luminescent and more particularly materials which combine the properties of both liquid crystals and luminescence, e.g. mesogenic phosphorescent metallomesogens.

In particular, the present invention is based on the discovery of novel materials which combine the properties of both liquid crystals and metal-organic OLEDs.

Thus, according to a first aspect of the invention we provide a non-planar iridium-ligand complex with accessible triplet states and a molecular structure that confers liquid-crystal like properties. The iridium-ligand complex will comprise a six coordinate complex.

The iridium-ligands system will comprise in general three bidentate ligands, two C,N ligands and one O,O ligand or four ligands, two bidentate C,N and two monodentate ligands that can be the same or different, as described herein.

It is generally understood that the unique properties of liquid crystals are due to the ability of liquid crystal molecules to align. However, molecules other than liquid crystals can be brought to alignment and therefore by the term “liquid crystal like” we mean molecules that can be so brought to alignment, i.e. “liquid crystal like” materials can be brought into alignment when in combination with an liquid crystal material, for example, a “liquid crystal like” material may be part of a mixture with other liquid crystal materials. Therefore, the term “liquid crystal like” shall include liquid crystals, but shall not be limited thereto.

In the non-planar iridium-ligand-complex of the invention the complex may comprise three or four ligands, including at least two different types of ligands and optionally three different types of ligand. Thus, for example, the iridium-ligand-complex will comprise a pair of identical C,N bidentate ligands and either two other monodentate ligands or a further single bidentate ligand.

A first ligand will generally be a bidentate donor ligand. Such bidentate donor ligands will include, inter alia, those bidentate ligands known from the prior art and hereinbefore described and which are incorporated herein by reference. Preferentially, such a ligand will comprise a bidentate C,N donor ligand. Preferably in the iridium complexes of the present invention the first and second ligands comprise a bidentate C,N donor ligand. Preferably the first and second bidentate C,N donor ligands are the same. An especially preferred C,N donor ligand is based on a 2,5-diphenylpyridine moiety, and especially a substituted 2,5-diphenylpyridine moiety, for example of the general formula I:

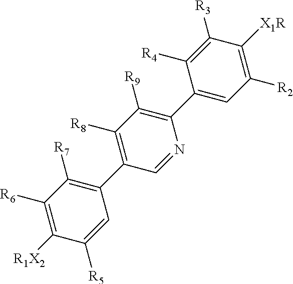

in which
(A) X₁ and X₂ are each a bond;
R is hydrogen, alkyl C1 to 30 or alkoxy C1 to 30;
R², R³ and R⁴ are each hydrogen;
R¹, R⁵, R⁶ and R⁷, which may be the same or different, are each hydrogen or alkoxy C1 to 30;
R⁸ and R⁹, which may be the same or different, are each hydrogen or R⁸ and R⁹ together form a 5- or 6-membered carbocyclic ring or a heterocyclic ring;
(B) X₁ and X₂ are each a bond;
R is hydrogen, alkyl C1 to 30 or alkoxy C1 to 30;
R², R³ and R⁴ are each hydrogen;
R¹ is alkyl C1 to 30 or alkoxy C1 to 30;
R⁵, R⁶ and R⁷ are each hydrogen;
R⁸ and R⁹, which may be the same or different, are each hydrogen or R⁸ and R⁹ together form a 5- or 6-membered carbocyclic ring or a heterocyclic ring;
(C) X₁ and X₂ are each a bond;
R¹ is hydrogen, alkyl C1 to 30 or alkoxy C1 to 30;
R⁵, R⁶ and R⁷, are each hydrogen;
R, R², R³, R⁴, which may be the same or different, are each hydrogen or alkoxy C1 to 30;
R⁸ and R⁹, which may be the same or different, are each hydrogen or R⁸ and R⁹ together form a 5- or 6-membered carbocyclic ring or a heterocyclic ring;
(D) X₁ and X₂ are each a bond;
one of R, R², R³, and R⁴ is alkoxy C1 to 30 and the remainder, which may be the same or different, are each hydrogen or alkoxy C1 to 30;
one of R¹, R⁵, R⁶ and R⁷ is alkoxy C1 to 30 and the remainder, which may be the same or different are each hydrogen or alkoxy C1 to 30;
provided that at least three of R, R¹, R², R³, R⁴, R⁵, R⁶ and R⁷ represents alkoxy C1 to 30; and
R⁸ and R⁹, which may be the same or different, are each hydrogen or R⁸ and R⁹ together form a 5- or 6-membered carbocyclic ring or a heterocyclic ring;
provided that when the third ligand is acac (as hereinafter defined) and each of R, R¹, R², R³, R⁴, R⁵, R⁶ and R⁷ are each hydrogen then —X₁R and —X₂R¹ do not both represent hydrogen, ethyl, methoxy or ethoxy.

The iridium complex of the invention especially comprises two C,N donor ligands as hereinbefore described.

It will be understood by the person skilled in the art that the ligands as hereinbefore described are generally in monoanionic form when incorporated in the iridium ligand complexes of the present invention. The ligand molecules used in the complexes of the invention are illustrated, by way of example only and should be considered to be non-limiting by the structures of formulae 1a-1n below:

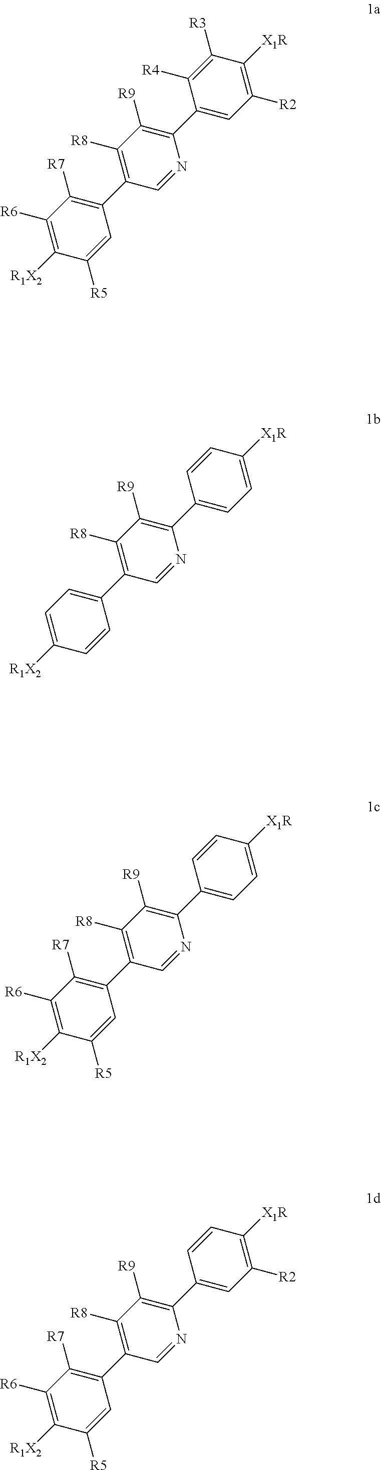

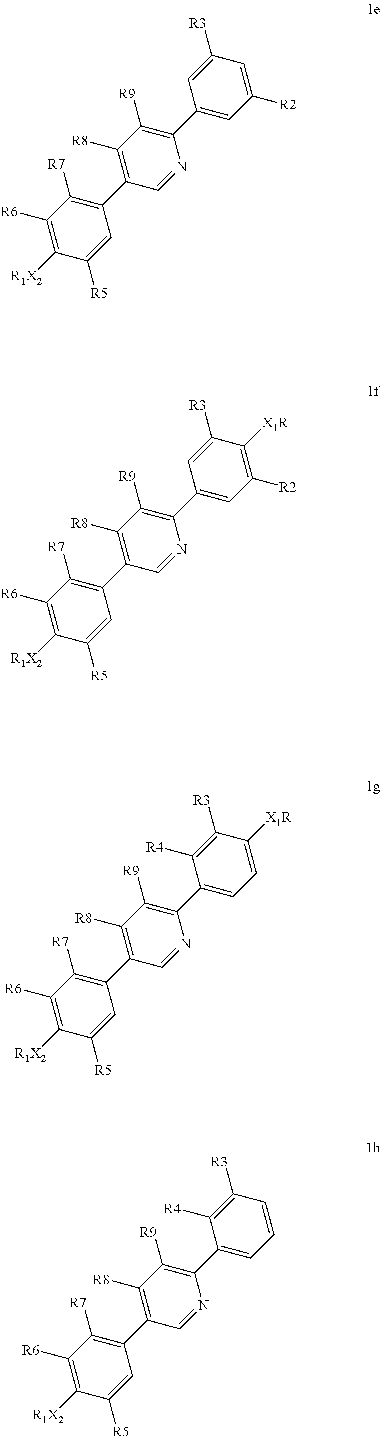

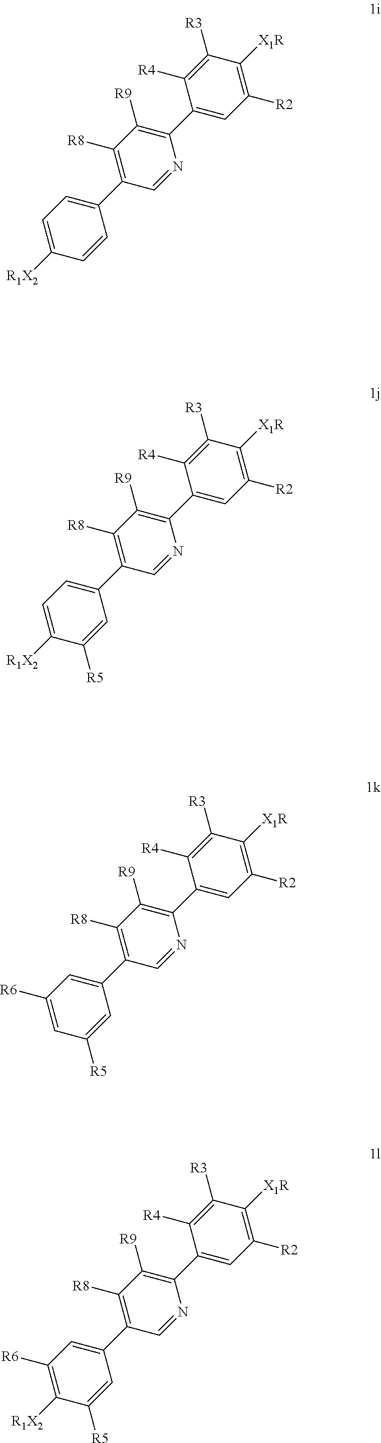

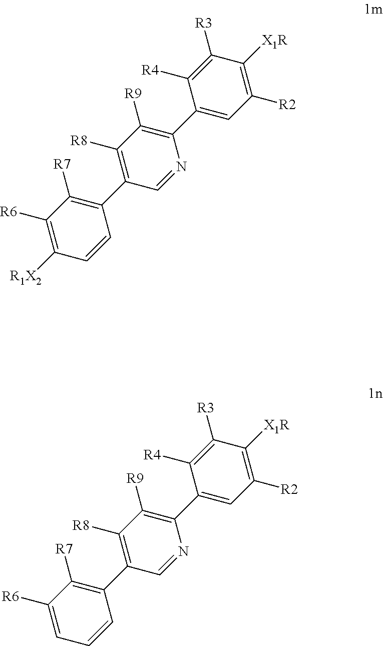

In one aspect of the present invention the iridium complex comprises at least one ligand comprising a compound of formula I;

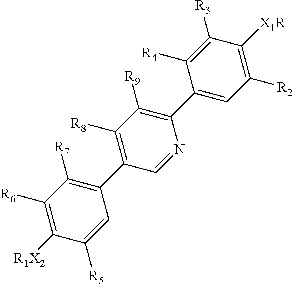

in which R⁸ and R⁹ are both hydrogen; and
R, R¹, R², R³, R⁴, R⁵, R⁶, R⁷, X₁ and X₂ are each as hereinbefore defined.

In another aspect of the present invention the iridium complex comprises at least one ligand comprising a compound of formula I in which R⁸ and R⁹ together form a 5- or 6-membered carbocyclic ring or a heterocyclic ring.

The iridium metal complexes of the present invention will generally comprise three or four ligands. The first and second ligands will comprise a pair of bidentate donor ligands as hereinbefore described, such as, a pair of bidentate C,N donor ligands.

The third and fourth ligands may comprise a single bidentate ligand or separate monodentate ligands, which may be the same or different. When the third and fourth ligands together comprises a single bidentate ligand, the single bidendate ligand may be selected from the group consisting of one or more of a nitro (NO₃) group, a diketone, such as an alkyl C1 to 10, haloalkyl C1 to 10, a diketone or a tetraketone, e.g. two diketones bounded to each other through carbon C3 (illustrated by the generic formula II). Monodentate ligands may be selected from the group consisting of a sulfoxide, such as a dimethyl sulfoxide, or carbon monoxide, e.g. in combination with a halogen, such as chlorine or a simple monodentate anionic ligand, such as, nitrile. The di-μ-chloro complexes may lead subsequently to emissive complexes including dimethyl sulfoxide (DMSO), carbon monoxide (CO) a bidentate O,O donor ligand, such as a diketone, e.g., acetylacetonate (acac).

Thus, according to this aspect of the invention we provide a non-planar iridium-ligand complex as hereinbefore described wherein the third and fourth ligands are selected from the group consisting of one or more of halogen, dimethyl sulfoxide (DMSO), carbon monoxide (CO) or a single bidentate O,O donor ligand as hereinbefore described.

The bidentate ligands as hereinbefore described, such as a bidentate O,O donor or a bidentate C,N donor, are generally in monoanionic form when incorporated in the iridium ligand complexes of the present invention. Therefore, below is illustrated the neutral molecular ligand (precursor) and the corresponding anionic ligand as incorporated into an iridium complex.

A non-planar metal-ligand complex wherein the third and fourth ligand is a single bidentate O,O donor ligand may be desirable. Thus, an especially preferred third and fourth ligand comprises a 2,4-diketone moiety of the general formula II;

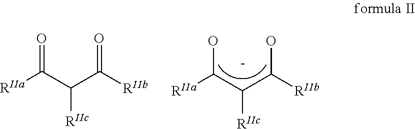

in which R^{IIa} and R^{IIb}, which may be the same or different, are each alkyl C1 to 10, preferably C1 to 6, or haloalkyl C1 to 10, preferably C1 to 6, such as trifluoromethyl; and R^{IIc} is hydrogen or a moiety of formula III;

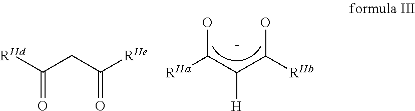

in which R^{IId} and R^{IIe}, which may be the same or different, are each alkyl C1 to 10, preferably C1 to 6, or haloalkyl C1 to 10, preferably C1 to 6, such as trifluoromethyl; and isomers thereof.

The present invention provides a non-planar iridium-ligand complex as hereinbefore described wherein the third ligand comprises a tetraketone. Such tetraketone complexes may be dimeric complex. Such dimeric complexes may comprise a pair iridium metal centres.

Thus, according to a further aspect of the invention we provide a non-planar metal-ligand complex as hereinbefore described wherein the third and fourth ligands each comprise a single bidentate ligand which is a tetraketone, such that the complex is of the generic formula IV;

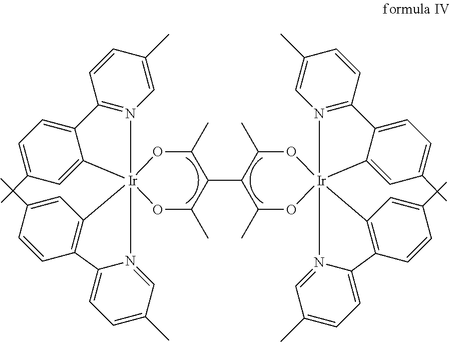

and all stereoisomers thereof.

It should be understood that in the complex formulae hereinbefore and hereinafter described the C,N bidentate ligands are shown in abbreviated form only.

Thus, an iridium complex of the invention may be represented by a complex of the generic formula V;

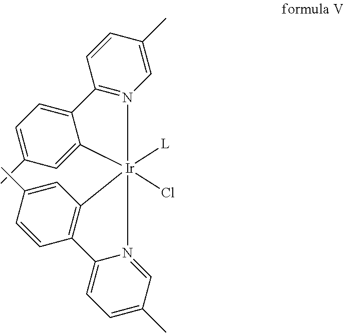

in which the C,N pairs each represent a bidentate ligand; and
L represents a ligand, e.g. a neutral ligand, selected from the group consisting of, dimethyl sulfoxide (DMSO) and carbon monoxide (CO).

The invention further provides a neutral non-planar iridium-ligand complex wherein the complex is of the generic formula VI;

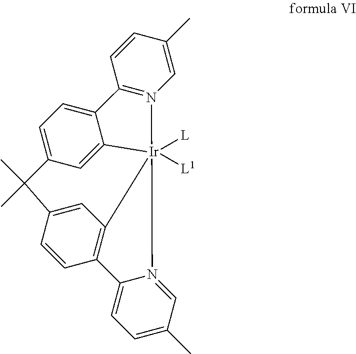

in which the C,N pairs each represent a bidentate ligand, and one of L and L¹ represents a neutral monodentate ligand and the other represents an anionic monodentate ligand (as represented by the complex of formula VII) or L and L¹ together represent a monoanionic bidentate ligand (as represented by the complex of formula VIII) and all stereoisomers thereof.

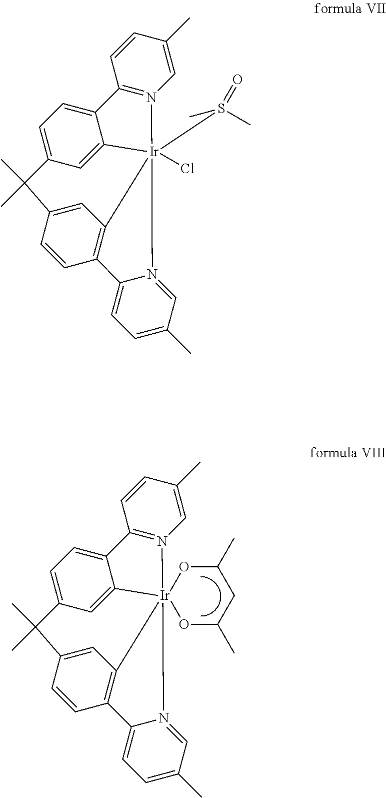

Alternatively, an iridium complex of the invention may be cationic and may be represented by a complex of the generic formula IX or X;

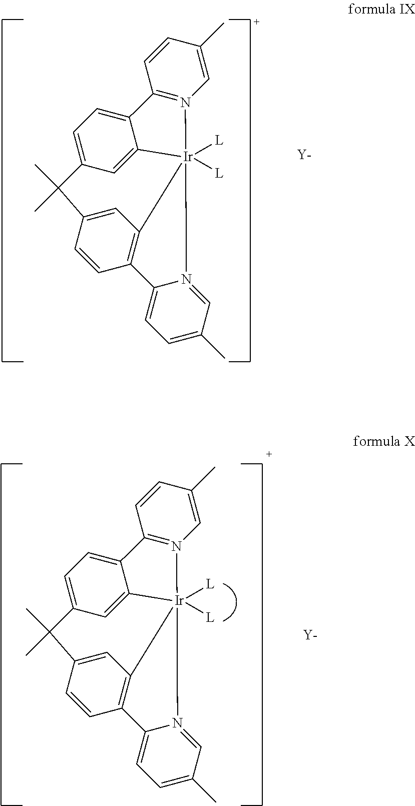

in which L represents a neutral monodentate ligand (as represented by the complex of formula IX) or 2Ls represent a bidentate ligand (as represented by the complex of formula X); and Y is an anion, e.g. a monovalent anion.

The iridium complex of the invention of the generic formulae IX or X is cationic, e.g. the complex may comprise a monovalent cation.

When the iridium complex comprises a monovalent cation as herein before described, the complex will be associated with an anion. Such an anion may be a monovalent anion, although it will be understood that anions of other valencies may be suitable. A variety of monovalent anion salts may comprise an inorganic or an organic anion. Inorganic anions, include, but shall not be limited to, bicarbonate/carbonate, bisulfate/sulfate, halide, e.g. chloride, bromide or iodide, nitrate, phosphate/hydrogen phosphate/dihydrogen phosphate, and the like. Organic anions include, but shall not be limited to, alkanoates, e.g. acetate, stearate, etc., aspartate, benzoate, citrate, formate, fumarate, lactate, malate, maleate, malonate, mesylate, alkyl sulphates, naphthylate, 2-napsylate, nicotinate, oxalate, palmitate, pamoate, succinate, tartrate, tosylate and trifluoroacetate, and the like.

The term “carbocyclic ring” as used herein means a saturated, unsaturated or aromatic, ring system containing 6 to 14 ring carbon atoms, which may be unsubstituted or substituted as defined and as described herein or as a known polycyclic liquid crystal as hereinbefore described.

The term “heterocyclic ring” as used herein means an optionally substituted, saturated or unsaturated non-aromatic 4-, 5-, 6-, or 7-membered ring that contains at least one heteroatom selected from O, S and N.

Alternatively a dimeric complex may be of the general formula XI:

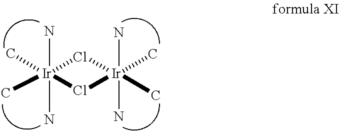

Such dimeric metal-ligand complexes are useful, inter alia, as intermediates in the preparation of the complexes of formula IV, V, VI, VII, VIII, IX and X, as hereinbefore described or may themselves be liquid crystalline or be liquid crystal like.

Thus, according to a further aspect of the invention we provide a non-planar metal-ligand complex wherein the complex is of the generic formula IX;

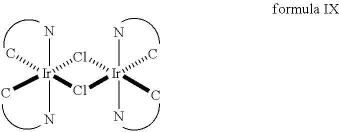

wherein C,N represent a bidentate donor ligand as hereinbefore described;
and optical- and meso-isomers thereof.

Certain of the bidentate C,N donor ligands used in the complexes of the invention are novel per se. In particular, those complexes in which one or more of R², R³, R⁴, R⁵, R⁶ and R⁷, which may be the same or different are each alkyl C1 to 30 or alkoxy C1 to 30 are novel.

Thus, according to a yet further aspect of the invention we provide a C,N donor ligand of the general formula I:

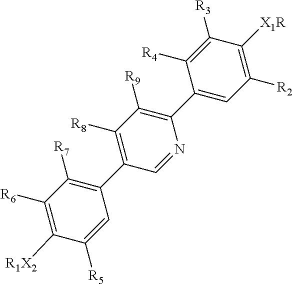

in which
(A) X₁ and X₂ are each a bond;
R is hydrogen, alkyl C1 to 30 or alkoxy C1 to 30;
R², R³ and R⁴ are each hydrogen;
R¹, R⁵, R⁶ and R⁷, which may be the same or different, are each hydrogen or alkoxy C1 to 30;
R⁸ and R⁹, which may be the same or different, are each hydrogen or R⁸ and R⁹ together form a 5- or 6-membered carbocyclic ring or a heterocyclic ring;
(B) X₁ and X₂ are each a bond;
R is hydrogen, alkyl C1 to 30 or alkoxy C1 to 30;
R², R³ and R⁴ are each hydrogen;
R¹ is alkyl C1 to 30 or alkoxy C1 to 30;
R⁵, R⁶ and R⁷ are each hydrogen;
R⁸ and R⁹, which may be the same or different, are each hydrogen or R⁸ and R⁹ together form a 5- or 6-membered carbocyclic ring or a heterocyclic ring:
(C) X₁ and X₂ are each a bond;
R¹ is hydrogen, alkyl C1 to 30 or alkoxy C1 to 30;
R⁵, R⁶ and R⁷, are each hydrogen;
R, R², R³ and R⁴, which may be the same or different, are each hydrogen or alkoxy C1 to 30;
R⁸ and R⁹, which may be the same or different, are each hydrogen or R⁸ and R⁹ together form a 5- or 6-membered carbocyclic ring or a heterocyclic ring;
(D) X₁ and X₂ are each a bond;
one of R, R², R³ and R⁴ is alkoxy C1 to 30 and the remainder, which may be the same or different, are each hydrogen or alkoxy C1 to 30;
one of R¹, R⁵, R⁶ and R⁷ is alkoxy C1 to 30 and the remainder, which may be the same or different are each hydrogen or alkoxy C1 to 30;
provide that at least three of R, R¹, R², R³, R⁵, R⁶ and R⁷ represents alkoxy C1 to 30; and
R⁸ and R⁹, which may be the same or different, are each hydrogen or R⁸ and R⁹ together form a 5- or 6-membered carbocyclic ring or a heterocyclic ring;
provided that at least one of R², R³, R⁴, R⁵, R⁶ and R⁷ is alkyl C1 to 30 or alkoxy C1 to 30.

Ligands and complexes of the invention and intermediates may be prepared by methods generally known per se. Other process schemes which may be utilised which include those set out below, particularly Schemes 1 and 2 for preparation of ligands:

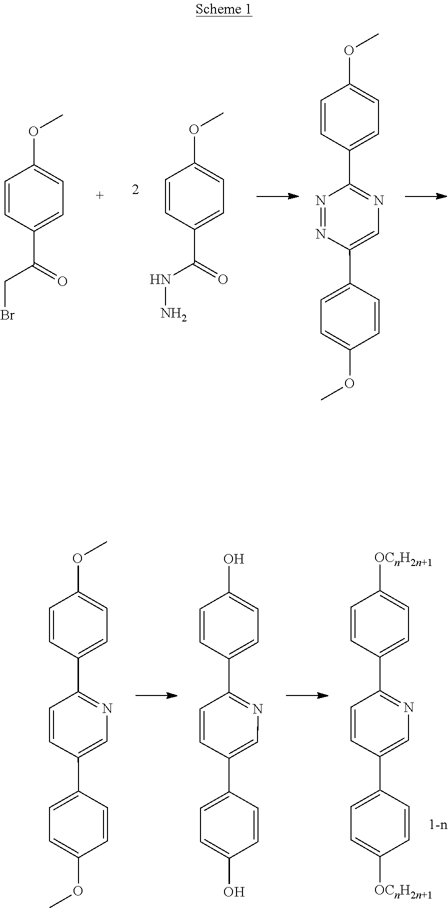

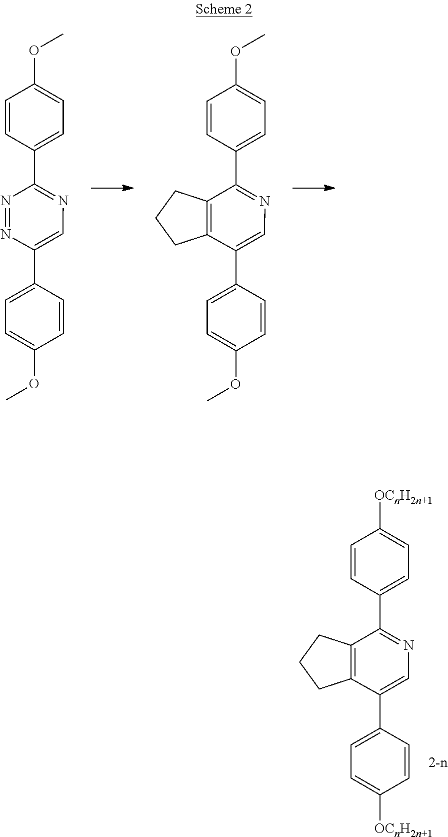

and Scheme 3 for preparation of the complexes:

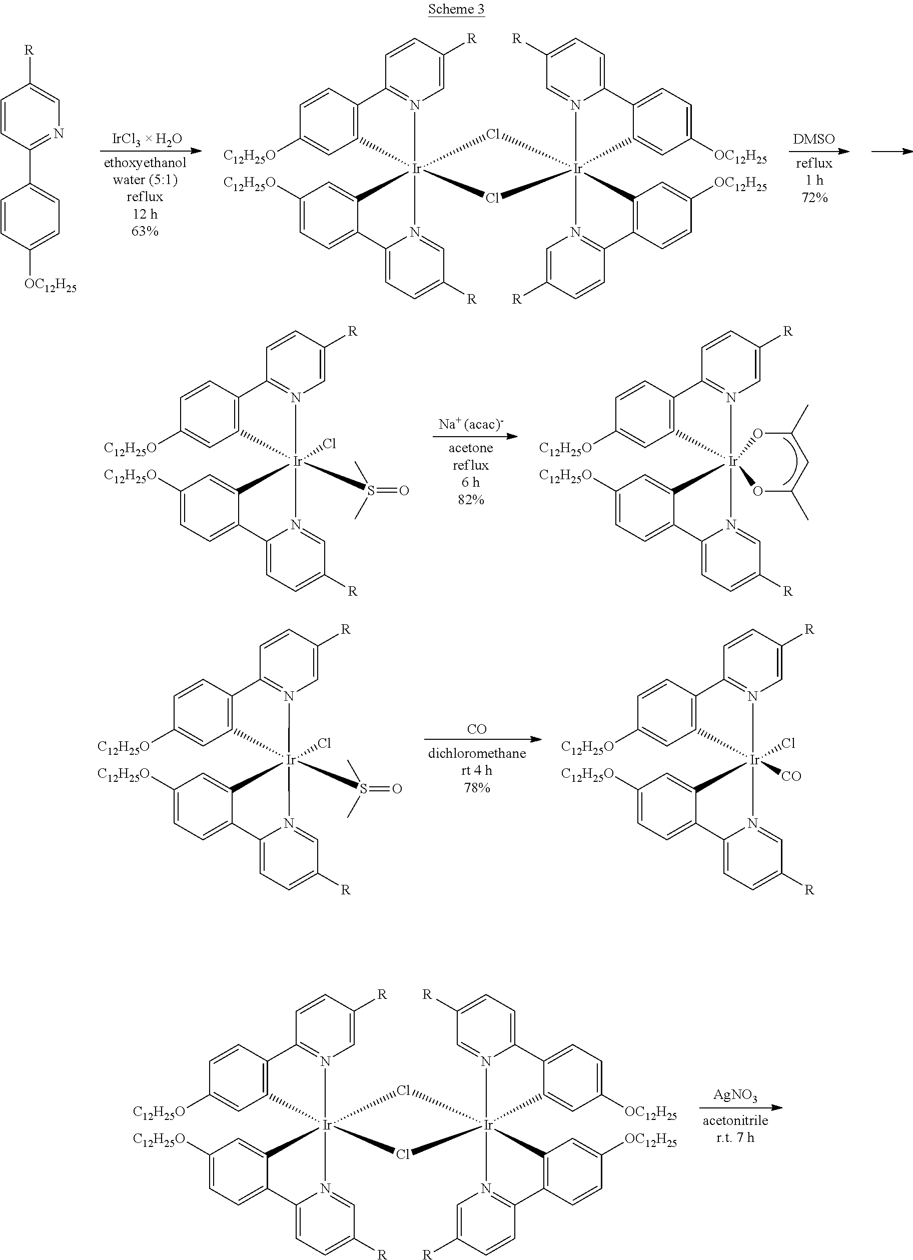

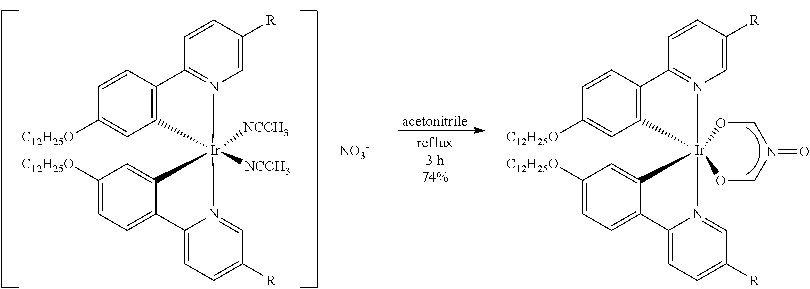

Other ligands and/or complexes described herein, may be prepared by such methods or analogues methods, including the method described in Schemes 1, 2 and 3, but starting from the corresponding carboxylic acids or acetophenones, each of which are commercially available and which would be understood by the person skilled in the art. Methods disclosed in a co-pending International patent application No. PCT/GB2010/000349 and methods analogous to those disclosed are also useful in the preparations of the ligands and/or complexes.

According to a further aspect of the invention we provide a material comprising a non-planar iridium-ligand complex, with accessible triplet states and a molecular structure that confers liquid-crystal like properties on the material as hereinbefore described. Thus, such a material is advantageous in that, inter alia, it is a luminophore and may also be a liquid crystal.

Thus, we also provide the use of the material as hereinbefore described in the manufacture of an electronic device. The material is advantageous in that, inter alia, such electronic devices or light sources may be more energy-efficient and/or brighter than conventionally known devices. It is within the scope of the present invention to provide a material comprising the non-planar organo-iridium luminophore as hereinbefore described in combination with one or more known liquid crystals.

In the following examples there is described the synthesis and properties of luminescent non-planar iridium-ligand complexes, which show liquid crystal mesophases or liquid crystal like behaviour.

Referring to the examples that follow, compounds of the preferred embodiments are synthesized using the methods described herein, or other methods, which are known in the art.

It should be understood that the organic ligands/complexes according to the invention may exhibit the phenomenon of isomerism. The chemical structures within this specification only represent one of the possible isomeric forms, it should be understood that the preferred embodiments encompasses any isomeric form of the drawn structure.

The invention will now be illustrated by way of example only.

### EXPERIMENTAL

### 1. Preparation of the Pyridine Ligands

### Two-Chain Ligand

### Example 1.1

### 2,5-Di(4-dodecyloxyphenyl)pyridine

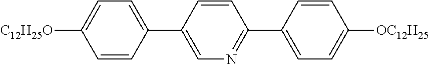

The ligand was prepared according to known procedures.

### Five-Chain Ligand

### Example 1.2

### Bromo-3′,4′,5′-trimethoxyacetophenone

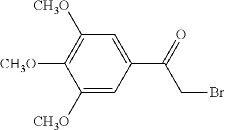

Bromine (23.8 mmol, 3.8 g) was added drop by drop to a solution of 3,4,5-trimethoxybenzophenone (23.8 mmol, 5.0 g) in diethyl ether (100 cm³) at room temperature. After complete addition the reaction was left to stir for 2 h. The diethyl ether solution was then washed with aqueous NaHCO₃ saturated. The organic fractions were collected, dried over anhydrous MgSO₄ and the solvent was removed by rotary-evaporation giving a colourless oil. Boiling ethanol (50 mL) was added to dissolve the residue and resulting-solution was cooled down to give white crystals of the product. Yield 5.0 g (17.3 mmol, 73%).

¹H-NMR δ_{H}(400 MHz, CDCl₃), 7.23 (2H, s), 4.40 (2H, s, —CH₂Br), 3.93 (3H, s, OCH₃), 3.91 (6H, s, OCH₃).

### Example 1.3

### 6-(3,4-Dimethoxyphenyl)-3-(3,4-dimethoxyphenyl)-1,2,4-triazine

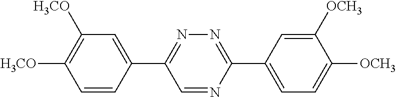 [SMILES: COc1ccc(-c2cnc(-c3ccc(OC)c(OC)c3)nn2)cc1OC]

3,4-Dimethoxybenzohydrazide (20.8 mmol, 4.08 g), 2-bromo-3′,4′-diimethoxy acetophenone (10.4 mmol, 2.70 g) and sodium acetate (15.6 mmol, 1.28 g) were added to a solution of ethanol and acetic acid (70 cm³, 7:3). The mixture was stirred and heated under reflux for 16 h, after which it was cooled slowly. The crystalline yellow precipitate was filtered off and washed with ethanol (10 cm³) to give a yellow, crystalline solid. Yield 1.5 g (4.2 mmol, 40%).

¹H-NMR δ_{H} (400 MHz, CDCl₃): 8.99 (1H, s, H⁶), 8.19 (1H, dd, ³J_{HH}=8.5 Hz, ⁴J=2.2 Hz, Ar), 8.15 (1H, d, ⁴J=1.8 Hz, Ar), 7.92 (1H, d, ⁴J=2.2 Hz, Ar), 7.57 (1H, dd ³J_{HH}=8.5 Hz, ⁴J=2.2 Hz, Ar), 7.02 (2H, m, Ar), 4.02 (3H, s, OCH₃), 4.00 (3H, s, OCH₃), 3.98 (3H, s, OCH₃), 3.97 (3H, s, OCH₃).

### Example 1.4

### 2-(3,4-Dimethoxyphenyl)-5-(3,4-dimethoxyphenyl)pyridine

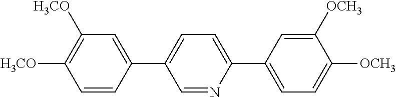 [SMILES: COc1ccc(-c2ccc(-c3ccc(OC)c(OC)c3)nc2)cc1OC]

6-(3,4-Dimethoxyphenyl)-3-(3,4-dimethoxyphenyl)-1,2,4-triazine (3.4 mmol, 1.20 g) was added to a solution of bicyclo[2.2.1]hepta-2,5-diene (34.0 mmol, 3.13 g) in 1,2-dichlorobenzene (30 cm³). The mixture was stirred and heated under reflux for 5 h. During the reaction more bicyclo[2.2.1]hepta-2,5-diene (34.0 mmol, 3.13 g) was added and the solution was left under reflux overnight, after which it was cooled, the solvent was removed by filtration and the solid washed with ethanol (50 cm³) to give a grey, crystalline solid. Yield 0.95 g (2.7 mmol, 80%).

¹H-NMR δ_{H} (400 MHz, CDCl₃): 8.82 (1H, d, ⁴J_{HH}=2.6 Hz, H⁶), 7.87 (1H, dd, ³J_{HH}=8.1 Hz, ⁴J_{HH}=2.2 Hz, H⁴), 7.71 (1H, d, ³J_{HH}=8.5 Hz, H³), 7.67 (1H, d, ⁴J_{HH}=2.1 Hz, Ar), 7.51 (1H, dd, ³J_{HH}=8.5 Hz, ⁴J=2.1 Hz, Ar), 7.13 (2H, m, Ar), 6.95 (2H, m, Ar) 4.00 (3H, s, OCH₃), 3.98 (3H, s, OCH₃), 3.97 (3H, s, OCH₃), 3.94 (3H, s, OCH₃).

### Example 1.4

### 2-(3,4-Didodecyloxyphenyl)-5-(3,4-didodecyloxyphenyl)pyridine

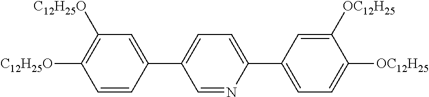

2-(3,4-Dimethoxyphenyl)-5-(3,4-dimethoxyphenyl)pyridine (2.7 mmol, 0.95 g) was added to molten pyridinium chloride (27.0 mmol, 3.12 g) at 200° C. and stirred for 16 h. After some cooling, the still warm mixture was added to water (50 cm³) and stirred for 15 minutes. The resulting solid was recovered by filtration and washed with water (30 cm³) and propanone (30 cm³), to give a green solid. These was added to a solution of 1-bromododecane (18.5 mmol, 4.61 g) and potassium carbonate (37.0 mmol, 5.11 g) in DMF (50 cm³). The solution was stirred at 100° C. under reflux for 12 h. Following cooling, the solid was recovered by filtration and washed with water (70 cm³), and ethanol (50 cm³), to give a colourless, crystalline solid. Yield 2.00 g (2.1 mmol, 75%).

¹H-NMR δ_{H} (400 MHz, CDCl₃): 8.83 (1H, d, ⁴J_{HH}=2.6 Hz, H⁶), 7.86 (1H, dd ³J_{HH}=8.1 Hz, ⁴J_{HH}=2.2 Hz, H⁴), 7.68 (1H, d, ³J_{HH}=8.5 Hz, H³), 7.66 (1H, d, ⁴J=2.1 Hz, Ar), 7.51 (1H, dd, ³J_{HH}=8.5 Hz, ⁴J=2.1 Hz, Ar), 7.14 (2H, m, Ar), 6.95 (2H, m, Ar) 4.11 (2H, m, OCH₂), 4.07-4.02 (6H, m, OCH₂), 1.85 (8H, m, CH₂), 1.47 (8H, m, CH₂), 1.25 (64H, broad m, CH₂), 0.86 (12H, m, CH₃). Anal. calcd. for C₆₅H₁₀₉NO₄: C, 80.60; H, 11.34; N, 1.45%. Found: C, 80.53; H, 11.33; N, 1.48%.

### Example 1.5

### 6-(3,4,5-Trimethoxyphenyl)-3-(3,4-dimethoxyphenyl)-1,2,4-triazine

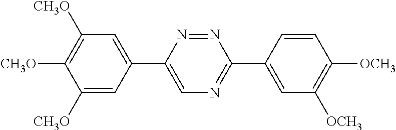

3,4-Dimethoxybenzohydrazide (34.6 mmol, 6.8 g), 2-bromo-3′,4′,5′-trimethoxy acetophenone (3.86 mmol, 1.00 g) and sodium acetate (26.0 mmol, 2.13 g) were added to a solution of ethanol and acetic acid (80 cm³, 7:3). The mixture was stirred and heated under reflux for 16 h after which it was cooled slowly. The crystalline yellow precipitate was filtered off and washed with ethanol (10 cm³) and diethyl ether (10 cm³) to give a yellow, crystalline solid. Yield 3.8 g (10.0 mmol, 57%).

¹H-NMR δ_{H} (400 MHz, CDCl₃): 8.98 (1H, s, H⁶), 7.71 (1H, d, ⁴J=2.1 Hz, Ar) 7.54 (1H, dd, ³J_{HH}=8.5 Hz, ⁴J=2.1 Hz, H⁹), 6.97 (1H, d, ³J=8.5 Hz, Ar), 6.79 (2H, m, Ar) 4.00 (3H, s, OCH₃), 3.97 (3H, s, OCH₃), 3.94 (3H, s, OCH₃), 3.93 (3H, s, OCH₃), 3.90 (3H, s, OCH₃).

### Example 1.6

### 2-(3,4-Dimethoxyphenyl)-5-(3,4,5-trimethoxyphenyl)pyridine

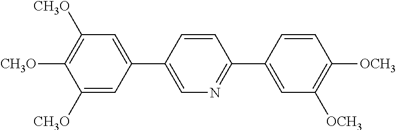

6-(3,4,5-Trimethoxyphenyl)-3-(3,4-dimethoxyphenyl)-1,2,4-triazine (6.5 mmol, 2.50 g) was added to a solution of bicyclo[2.2.1]hepta-2,5-diene (32.5 mmol, 3.0 g) in 1,2-dichlorobenzene (20 cm³). The mixture was stirred and heated under reflux for 5 h. During the reaction more bicyclo[2.2.1.]hepta-2,5-diene (32.5 mmol, 3.0 g) was added and the solution was left under reflux overnight, after which it was cooled, the solvent was removed by filtration and the solid washed with ethanol (50 cm³) to give a grey, crystalline solid. Yield 1.50 g (3.9 mmol, 60%).

¹H-NMR δ_{H} (400 MHz, CDCl₃): 8.85 (1H, d, ⁴J_{HH}=2.6 Hz, H⁶), 7.89 (1H, dd, ³J_{HH}=8.1 Hz, ⁴J_{HH}=2.2 Hz, H⁴), 7.74 (1H, d, ³J_{HH}=8.5 Hz, H³), 7.71 (1H, d, ⁴J=2.1 Hz, Ar), 7.54 (1H, dd, ³J=8.5 Hz, ⁴J=2.1 Hz, Ar), 6.97 (1H, d, ³J_{HH}=8.5 Hz, Ar), 6.79 (2H, m, Ar) 4.00 (3H, s, OCH₃), 3.97 (3H, s, OCH₃), 3.94 (3H, s, OCH₃), 3.93 (3H, s, OCH₃), 3.90 (3H, s, OCH₃).

### Example 1.7

### 2-(3,4-Hydroxyphenyl)-5-(3,4,5-trihydroxyphenyl)pyridine

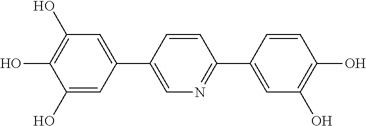 [SMILES: Oc1ccc(-c2ccc(-c3cc(O)c(O)c(O)c3)cn2)cc1O]

2-(3,4-Dimethoxyphenyl)-5-(3,4,5-trimethoxyphenyl)pyridine (3.9 mmol, 1.50 g) was added to molten pyridinium chloride (39.0 mmol, 4.50 g) at 200° C. and stirred for 16 h. After some cooling, the still warm mixture was added to water (50 cm³) and stirred for 15 minutes. The resulting solid was recovered by filtration and washed with water (30 cm³) and propanone (30 cm³), to give a green solid. Yield 1.0 g (3.2 mmol, 82%).

¹H-NMR δ_{H} (400 MHz, CDCl₃): 10.11 (not integrable, broad s, OH), 9.87 (not integrable, broad s, OH), 8.66 (1H, d, ⁴J_{HH}=2.6 Hz, H⁶), 8.39 (1H, dd, ³J_{HH}=8.1 Hz, ⁴J_{HH}=2.2 Hz, H⁴), 8.04 (1H, d, ³J_{HH}=8.5 Hz, H³), 7.44 (1H, d, ⁴J 2.1 Hz, Ar) 7.36 (1H, dd, ³J_{HH}=8.5 Hz, ⁴J=2.1 Hz, Ar), 6.90 (1H, d, ³J_{HH}=8.5 Hz, Ar), 6.69 (2H, m, Ar).

### Example 1.8

### 2-(3,4,-Didodecyloxyphenyl)-5-(3,4,5-tridodecyloxyphenyl)pyridine

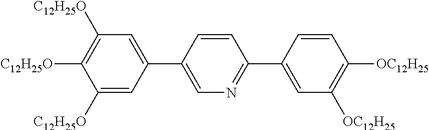

2-(3,4-Hydroxyphenyl)-5-(3,4,5-trihydroxyphenyl)pyridine (2.90 mmol, 0.90 g) was added to a solution of 1-bromododecane (18.8 mmol, 4.69 g) and potassium carbonate (29.00 mmol, 4.01 g) in DMF (50 cm³). The solution was stirred at 100° C. under reflux for 12 h. Following cooling, the solid was recovered by filtration and washed with water (70 cm³), and ethanol (50 cm³), to give a colourless, crystalline solid. Yield 1.09 g (1.40 mmol, 39%).

¹H-NMR δ_{H} (400 MHz, CDCl₃): 8.82 (1H, d, ⁴J_{HH}=2.6 Hz, H⁶), 7.85 (1H, dd, ³J_{HH}=8.1 Hz, ⁴J_{HH}=2.2 Hz, H⁴), 7.71 (1H, d, ³J_{HH}=8.5 Hz, H³), 7.67 (1H, d, ⁴J=2.1 Hz, Ar) 7.52 (1H, dd, ³J_{HH}=8.5 Hz, ⁴J=2.1 Hz, Ar), 6.96 (1H, d, ³J_{HH}=8.5 Hz, Ar), 6.76 (2H, m, Ar) 4.11 (2H, m, OCH₂), 4.10-3.97 (8H, m, OCH₂), 1.85 (10H, m, CH₂), 1.50 (10H, m, CH₂), 1.25 (80H, broad m, CH₂), 0.86 (15H, m, CH₃). Anal. calcd. for C₇₇H₁₃₃NO₅: C, 80.22; H, 11.63; N, 1.21%. Found: C, 80.07; H, 11.48; N, 1.20%.

### Example 1.9

### 2-(3,4-Dimethoxyphenyl)-5-(2,3,4-trimethoxyphenyl)pyridine

### (a) Bromo-2′,3′,4′-trimethoxyacetophenone

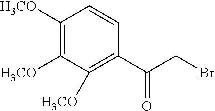 [SMILES: COc1ccc(C(=O)CBr)c(OC)c1OC]

Bromine (23.80 mmol, 3.80 g) was added drop by drop to a solution of 2,3,4-trimethoxybenzophenone (23.80 mmol, 5.00 g) in diethyl ether (100 cm³) at room temperature. After complete addition the reaction was left to stir for 1 h. The diethyl ether solution was then washed with aqueous NaHCO₃ saturated and then brine. The organic fractions were collected, dried over anhydrous MgSO₄ and the solvent was removed by rotary-evaporation giving a white solid. Yield 3.60 g (12.50 mmol, 53%).

¹H-NMR δ_{H} (270 MHz, CDCl₃): 7.59 (1H, dd, ³J_{HH}=9.2 Hz, Ar), 6.72 (1H, d, ³J_{HH}=9.2 Hz, Ar), 4.52 (2H, s, —CH₂Br), 4.03 (3H, s, OCH₃), 3.90 (3H, s, OCH₃), 3.85 (3H, s, OCH₃).

### (b) 6-(2,3,4-Trimethoxyphenyl)-3-(3,4-dimethoxyphenyl)-1,2,4-triazine

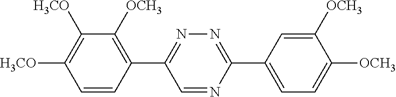 [SMILES: COc1ccc(-c2ncc(-c3ccc(OC)c(OC)c3OC)nn2)cc1OC]

3,4-Dimethoxybenzohydrazide (25.0 mmol, 4.91 g), 2-bromo-2′,3′,4′-triimethoxy acetophenone (12.5 mmol, 3.60 g) and sodium acetate (2.05 g, 25 mmol) were added to a solution of ethanol and acetic acid (70 cm³, 7:3). The mixture was stirred and heated under reflux for 16 h. after which it was cooled slowly. The crystalline yellow precipitate was filtered off and washed with ethanol (10 cm³) to give a yellow, crystalline solid. Yield 2.0 g (5.2 mmol, 42%).

¹H-NMR δ_{H} (400 MHz, CDCl₃): 9.13 (1H, s, H⁶), 8.19 (1H, dd ³J_{HH}=8.5 Hz, ⁴J=2.2 Hz, Ar), 8.15 (1H, d, ⁴J=1.8 Hz, Ar), 7.83 (1H, d, ⁴J=2.2 Hz, Ar), 7.02 (1H, dd, ³J_{HH}=9.2 Hz, Ar), 6.87 (1H, dd, ³J_{HH}=9.2 Hz, Ar), 4.02 (3H, s, OCH₃), 3.97 (3H, s, OCH₃), 3.942 (3H, s, OCH₃), 3.94 (3H, s, OCH₃), 3.88 (3H, s, OCH₃).

### (c) 2-(3,4-Dimethoxyphenyl)-5-(2,3,4-trimethoxyphenyl)pyridine

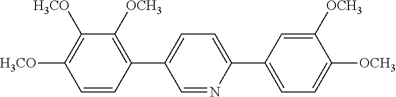 [SMILES: COc1ccc(-c2ccc(-c3ccc(OC)c(OC)c3OC)cn2)cc1OC]

6-(3,4-Dimethoxyphenyl)-3-(2,3,4-trimethoxyphenyl)-1,2,4-triazine (4.7 mmol, 1.80 g) was added to a solution of bicyclo[2.2.1]hepta-2,5-diene (34.0 mmol, 3.13 g) in 1,2-dichlorobenzene (30 cm³). The mixture was stirred and heated under reflux for 5 h. During the reaction more bicyclo[2.2.1.]hepta-2,5-diene (34.0 mmol, 3.13 g) was added and the solution was left under reflux overnight, after which it was cooled, the solvent was removed by filtration and the solid washed with ethanol (50 cm³) to give a grey, crystalline solid. Yield 1.30 e (3.4 mmol, 72%).

¹H-NMR δ_{H} (400 MHz, CDCl₃): 8.77 (1H, d, ⁴J_{HH}=2.6 Hz, H⁶), 7.88 (1H, dd, ³J_{HH}=8.1 Hz, ⁴J_{HH}=2.2 Hz, H⁴), 7.71 (2H, m, Ar+H³), 7.55 (1H, dd, ³J_{HH}=8.5 Hz, ⁴J=2.1 Hz, Ar), 7.08 (1H, d, ³J_{HH}=9.2 Hz, Ar), 6.96 (1H, d, ³J_{HH}=9.2 Hz, Ar), 6.78 (1H, d, ³J=9.2 Hz, Ar), 4.09 (3H, s, OCH₃), 3.94 (3H, s, OCH₃), 3.93 (3H, s, OCH₃), 3.89 (3H, s, OCH₃), 3.73 (3H, s, OCH₃).

### Example 1.10

### 2-(3,4,-Didodecyloxyphenyl)-5-(2,3,4-tridodecyloxyphenyl)pyridine

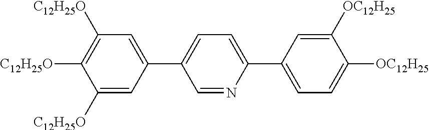

2-(3,4-Dimethoxyphenyl)-5-(2,3,4-trimethoxyphenyl)pyridine (3.4 mmol, 1.30 g) was added to molten pyridinium chloride (34.0 mmol, 3.94 g) at 200° C. and stirred for 16 h. After some cooling, the still warm mixture was added to water (50 cm³) and stirred for 15 minutes. The resulting solid was recovered by filtration and washed with water (30 cm³) and propanone (30 cm³), to give a green solid. These was added to a solution of 1-bromododecane (15.0 mmol, 3.75 g) and potassium carbonate (25.0 mmol, 3.46 g) in DMF (50 cm³). The solution was stirred at 100° C. under reflux for 12 h. Following cooling, the solid was recovered by filtration and washed with water (70 cm³), and ethanol (50 cm³), to give a colourless, crystalline solid. Yield 2.30 g (1.99 mmol, 59%).

¹H-NMR δ_{H} (400 MHz, CDCl₃): 8.74 (1H, d, ⁴J_{HH}=2.6 Hz, H⁶), 7.89 (1H, dd, ³J_{HH}=8.1 Hz, ⁴J_{HH}=2.2 Hz, H⁴), 7.67 (2H, m, Ar+H³), 7.52 (1H, dd, ³J_{HH}=8.5 Hz, ⁴J=2.1 Hz, Ar), 7.02 (1H, d, ³J_{HH}=9.2 Hz, Ar), 6.94 (1H, d, ³J_{HH}=9.2 Hz, Ar), 6.73 (1H, d, ³J 9.2 Hz, Ar), 4.10 (2H, m, OCH₂), 4.05-3.99 (6H, m, OCH₂), 3.80 (2H, m, OCH₂), 1.81 (8H, m, CH₂), 1.52 (12H, m, CH₂), 1.25 (90H, broad m, CH₂), 0.86 (15H, m, CH₃). Anal. calcd. for C₇₇H₁₃₃NO₅: C, 80.22; H, 11.63; N, 1.21%. Found: C, 80.00; H, 11.57; N, 1.29%.

### Six-Chain Ligand

### Example 1.11

### 3,6-Di(3,4,5-trimethoxyphenyl)-1,2,4-triazine

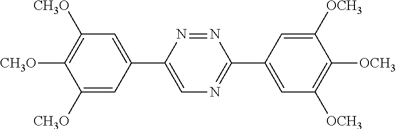

3,4,5-Trimethoxybenzohydrazide (34.6 mmol, 7.83 g), 2-bromo-3′,4′,5′-trimethoxyacetophenone (17.3 mmol, 5.00 g) and sodium acetate (34.6 mmol, 2.84 g) were added to a solution of ethanol and acetic acid (80 cm³, 7:3). The mixture was stirred and heated under reflux for 16 h, after which it was cooled slowly. The crystalline yellow precipitate was filtered off and washed with ethanol (10 cm³) to give a yellow, crystalline solid. Yield 3.1 g (7.5 mmol, 57%).

¹H-NMR δ_{H} (400 MHz, CDCl₃): 8.89 (1H, s, H⁶), 7.87 (2H, s, Ar) 7.40 (2H, s, Ar), 3.98 (6H, s, OCH₃), 3.97 (6H, s, OCH₃), 3.94 (3H, s, OCH₃), 3.93 (3H, s, OCH₃).

### Example 1.12

### 2,5-Di(3,4,5-trimethoxyphenyl)pyridine

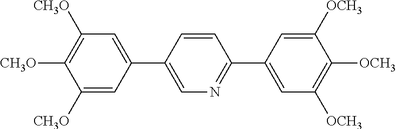

3,6-Di(3,4,5-trimethoxyphenyl)-1,2,4-triazine (7.5 mmol, 3.10 g), was added to a solution of bicyclo[2.2.1]hepta-2,5-diene (75.0 mmol, 6.90 g) in 1,2-dichlorobenzene (20 cm³). The mixture was stirred and heated under reflux for 5 h. During the reaction more bicyclo[2.2.1.]hepta-2,5-diene (32.5 mmol, 3.5 g) was added and the solution was left under reflux overnight, after which it was cooled, the solvent was removed by filtration and the solid washed with ethanol (50 cm³) to give a grey, crystalline solid. Yield 2.50 g (6.1 mmol, 81%).

¹H-NMR δ_{HH} (400 MHz, CDCl₃): 8.86 (1H, d, ⁴J_{HH}=2.6 Hz, H⁶), 7.89 (1H, dd, ³J_{HH}=8.1 Hz, ⁴J_{HH}=2.2 Hz, H⁴), 7.74 (1H, d, ³J_{HH}=8.5 Hz, H³), 7.29 (2H, s, Ar) 6.79 (2H, s, Ar), 3.97 (6H, s, OCH₃), 3.96 (6H, s, OCH₃), 3.914 (3H, s, OCH₃), 3.90 (3H, s, OCH₃).

### Example 1.13

### 2,5-Di(3,4,5-tridodecyloxyphenyl)pyridine

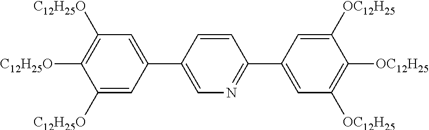

2,5-Di(3,4,5-trimethoxyphenyl)pyridine (6.1 mmol, 2.50 g) was added to molten pyridinium chloride (61.0 mmol, 7.05 g) at 200° C. and stirred for 16 h. After some cooling, the still warm mixture was added to water (50 cm³) and stirred for 15 minutes. The resulting solid was recovered by filtration and washed with water (30 cm³), to give a brown-green solid. It was dried and without further purification, the solid was added to a solution of 1-bromododecane (38.5 mmol, 9.6 g) and potassium carbonate (55.00 mmol, 7.60 g) in DMF (50 cm³). The solution was stirred at 100° C. under reflux for 12 h. Following cooling, the solid was recovered by filtration and washed with water (70 cm³), and ethanol (50 cm³), to give a colourless, crystalline solid. Yield 4.0 g (3.00 mmol, 50%).

¹H-NMR δ_{H} (400 MHz, CDCl₃): 8.83 (1H, d, ⁴J_{HH}=2.6 Hz, H⁶), 7.85 (1H, dd, ³J_{HH}=8.1 Hz, ⁴J=2.2 Hz, H⁴), 7.68 (1H, d, ³J_{HH}=8.5 Hz, H³), 7.23 (1H, s, Ar) 6.76 (1H, s, Ar), 4.10-3.97 (12H, m, OCH₂), 1.80 (12H, m, CH₂), 1.44 (12H, m, CH₂), 1.25 (96H, broad m, CH₂), 0.88 (18H, m, CH₃). Anal. calcd. for C₈₉H₁₅₇NO₆: C, 79.94; H, 11.83; N, 1.05%. Found: C, 80.05; H, 11.90; N, 1.07%.

### Preparation of Iridium (III) Complexes

### 2. Ir Complexes with Monomeric Ligands

### Example 2.1

### μ-Dichloro Iridium Dimer

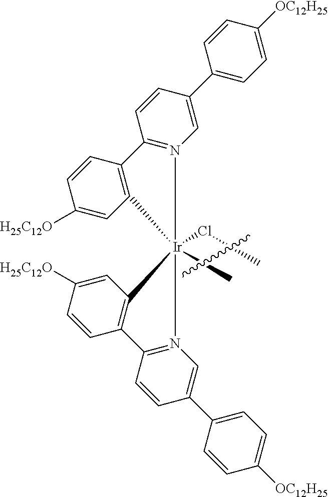

IrCl₃.3H₂O (1.58 mmol, 0.556 g) was added to a solution of 2,5-di(4-dodecyloxyphenyl)pyridine (3.00 mmol, 1.799 g) in ethoxyethanol (50 cm³) and water (10 cm³); the mixture was stirred and heated under vigorous reflux for 12 h. The solution was cooled to room temperature and the yellow-orange precipitate was collected by filtration. The precipitate was washed with ethanol (20 cm³) and propanone (20 cm³). The product was purified on a silica column with CH₂Cl₂/petroleum ether (60/90) (6:4). Yield 1.49 g (0.52 mmol, 66%).

¹H-NMR δ_{HH} (270 MHz, CDCl₃): 9.31 (2H, s, H⁶), 7.53 (2H, d, ³J_{HH}=8.9 Hz, Ar), 7.28 (2H, s-covered by solvent signal, Ar), 6.97 (2H, d, ³J_{HH}=8.17 Hz, Ar), 6.52 (4H, d, J=8.54 Hz, AA‘XX’), 6.17 (2H, d, ³J_{HH}=8.17 Hz, Ar), 5.55 (2H, s, H⁷), 3.76 (4H, m, OCH₂), 3.47 (4H, t, 1.70 (4H, m, CH₂), 1.24 (76H, broad in, CH₂), 0.80 (12H, m, CH₃). Anal. calcd. for C₁₆₄H₂₄₀Cl₂Ir₂N₄O₈: C, 69.09; H, 8.48; N, 1.97%. Found: C, 69.39; H, 8.30; N, 1.81%.

### Example 2.2

### Ir-dmso

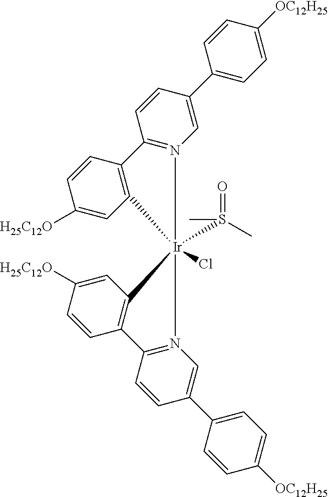

Complex of Example 2.1 (0.07 mmol, 0.200 g) was dissolved in the minimum amount of DMSO (˜20 cm³). The solution was refluxed for 30 min to 1 h. The solution was cooled at room temperature and the product recovered by filtration. Yield: 0.194 g (0.129 mmol, 92%). Unstable, hence poor CHN data.

¹H-NMR δ_{H} (270 MHz, CDCl₃): 10.27 (1H, d, ⁴J_{HH}=1.86 Hz, H⁶), 9.99 (1H, d, ⁴J_{HH}=1.86 Hz, H⁶), 7.97 (2H, m, Ar), 7.68 (6H, m, Ar), 7.47 (2H, d, J=8.91 Hz, AA‘XX’), 7.26 (2H, covered by solvent signal, Ar), 6.99 (2H, d, J_{HH}8.54 Hz, Ar), 6.45 (2H, m), 6.00 (1H, d, ⁴J_{HH}=2.23 Hz, H⁷), 5.41 (1H, d, ⁴J_{HH}=2.23 Hz, ′H⁷), 3.98 (4H, m, OCH₂), 3.59 (4H, broad m, OCH₂), 3.16 (3H, s, S—CH₃), 2.06 (3H, s, S—CH₃), 1.79 (4H, broad m, CH₂), 1.25 (76H, broad m, CH₂), 0.80 (12H, t, CH₃). Anal. calcd. for C₈₄H₁₂₆ClIrN₂O₅S: C, 67.10; H, 8.45; N, 1.86%. Found: C, 64.39; H, 8.51; N, 1.75%.

### Example 2.3

### Ir-ACN

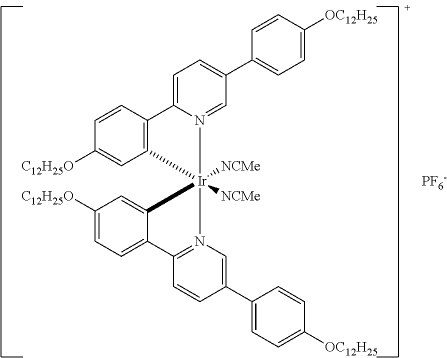

Complex of Example 2.1 (0.074 mmol, 0.212 g) was dissolved in boiling acetonitrile (25 cm³) and AgPF₆ (0.16 mmol 0.041 g) was added to this solution. The mixture was stirred at room temperature for 5 h and then the solvent was removed. The product was the solubilised in CH₂Cl₂ and filtered through celite, and then the product was precipitated by the addition of ethanol, filtered and washed with ethanol (20 cm³). Yield: 0.115 g (0.071 mmol, 48%).

¹H-NMR δ_{H} (270 MHz, CDCl₃): 9.05 (2H, d, ⁴J_{HH}=1.8 Hz, H⁶), 8.01 (2H, dd, ³J_{HH}=8.6 Hz, ⁴J_{HH}=1.9 Hz, H⁴), 7.77 (2H, d ³J_{HH}=8.7 Hz, H³), 7.68 (4H, d, J=8.5 Hz, AA‘XX’), 7.47 (2H, d, ³J_{HH}=8.5 Hz, H⁹), 7.08 (4H, d, J=8.5 Hz, AA‘XX’), 6.45 (2H, dd, ³J_{HH}=8.4 Hz, ⁴J_{HH}=1.9 Hz, H⁸), 5.61 (2H, d, ⁴J_{HH}=2.2 Hz, H⁷), 4.02 (4H, m, OCH₂), 3.61 (4H, m, OCH₂), 2.35 (6H, s, NC—CH₃), 1.79 (4H, m, CH₂), 1.50 (4H, m CH₂), 1.25 (72H, broad m, CH₂), 0.86 (12H, m, CH₃). Anal. calcd. for C₈₆H₁₂₆IrN₄O₄PF₆: C, 63.88; H, 7.85; N, 3.46%. Found: C, 63.63; H, 7.71; N, 3.29%.

### Example 2.4

### μ-Dichloro Iridium Dimer 5-Chains

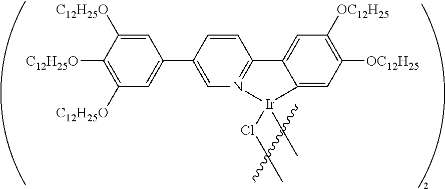

IrCl₃.3H₂O (0.10 mmol, 0.035) was added to a solution of 2-(3,4,-didodecyloxyphenyl)-5-(3,4,5-tridodecyloxyphenyl)pyridine (0.22 mmol, 0.25 g) in ethoxyethanol (20 cm³) and water (5 cm³); the mixture was stirred and heated under vigorous reflux for 12 h. The solution was cooled to room temperature and the yellow precipitate was collected by filtration. The precipitate was washed with water (10 cm³) and ethanol (10 cm³). The product was purified on a silica column with CH₂Cl₂/petroleum ether (60/90)(6:4) Yield 0.20 g (0.039 mmol, 74%).

¹H-NMR δ_{H} (400 MHz, CDCl₃): 9.59 (2H, d, ³J_{HH}=1.8 Hz, H⁶), 7.36 (2H, d, ³J_{HH}=8.8 Hz, H³), 7.25 (2H, dd, covered by solvent signal, H⁴), 6.94 (4H, s, Ar), 6.19 (2H, s, Ar), 5.31 (2H, s, Ar), 3.97 (4H, m, OCH₂), 3.80 (12H, m, OCH₂), 3.25 (4H, m, OCH₂), 1.74 (16H, m, CH₂), 1.22 (184H, broad m, CH₂), 0.85 (30H, m, CH₃). Anal. calcd. for C₃₀₈H₅₂₈Cl₂Ir₂N₄O₂₀: C, 73.07; H, 10.51; N, 1.11%. Found: C, 73.15; H, 10.47; N, 1.18%.

### Example 2.5

### CO—Ir

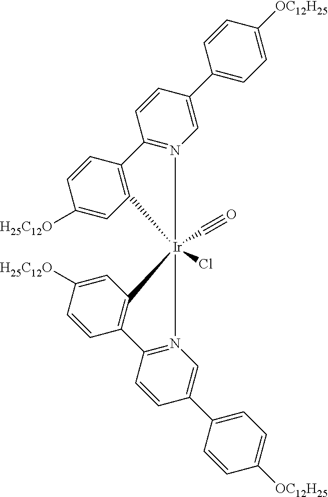

Complex of example 2.2 (0.07 mmol, 0.050 g) was dissolved in dichloromethane (15 cm³). The solution was stirred under an atmosphere of CO for 3 h. The solvent was removed under vacuum to yield a quantitative amount of the desired product (0.047

¹H-NMR δ_{H} (270 MHz, CDCl₃): 10.30 (1H, d, ⁴J_{HH}=1.86 Hz, H⁶), 9.16 (1H, d, ⁴J_{HH}=1.86 Hz, ′H⁶), 8.06 (1H, dd, ³J_{HH}=8.5 Hz, ⁴J_{HH}=2.2 Hz, Ar), 7.98 (1H, dd, ³J_{HH}=8.5 Hz, ⁴J_{HH}=2.2 Hz, Ar), 7.79 (2H, m, Ar), 7.60 (6H, m, Ar), 7.00 (3H, m, Ar), 6.49 (3H, m, Ar), 5.96 (1H, d, ⁴J_{HH}=2.3 Hz, H⁷), 5.55 (1H, d, ⁴J_{HH}=2.25 Hz, ′H⁷), 4.00 (4H, m, OCH₂), 3.62 (4H, broad m, OCH₂) 1.81 (4H, broad m, CH₂), 1.25 (76H, broad m, CH₂), 0.86 (12H, t, CH₃).

### Example 2.6

### CAN-Ir cation

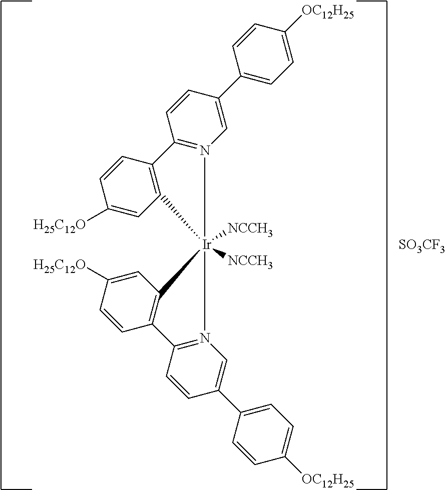

Complex of example 2.1 (0.049 mmol, 0.140 g) was dissolved in acetonitrile (25 cm³) and AgSO₃CF₃ (0.10 mmol 0.025 g) was added to this solution. The mixture was stirred at room temperature for 7 h and after this time the solvent was removed in cold condition. The product was the solubilised in CH₂Cl₂ and filtered through celite, then the Product was precipitate by the addition of acetone, filtered and washed with methanol (20 cm³). Yield: 0.055 g (0.034 mmol, 70%)

¹H-NMR δ_{H} (270 MHz, CDCl₃): 8.07 (2H, d, ⁴J_{HH}=1.8 Hz, H⁶), 8.00 (2H, dd, ³J_{HH}=8.6 Hz, ⁴J_{HH}=1.9 Hz, H⁴), 7.77 (2H, d ³J_{HH}=8.7 Hz, H³), 7.70 (4H, d, J=8.5 Hz, AA‘XX’), 7.47 (2H, d, ³J_{HH}=8.2 Hz, H⁹), 7.07 (4H, d, J=8.5 Hz, AA‘XX’), 6.46 (2H, dd, ³J_{HH}=8.4 HZ, ⁴J_{HH}=1.9 Hz, H⁸), 5.62 (2H, s, ⁴J_{HH}=2.2 Hz, H⁷), 4.02 (4H, m, OCH₂), 3.63 (4H, m, OCH₂), 2.42 (6H, s, NC—CH₃), 1.79 (4H, m, CH₂), 1.50 (4H, m, CH₂), 1.25 (72H, broad m, CH₂), 0.86 (12H, m, CH₃).

### 3. Ir complexes with Bidentate Ligands

### Example 3.1

### Ir-acac

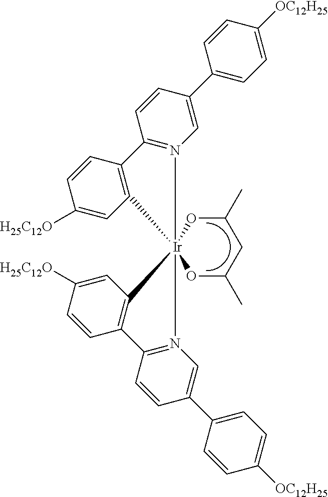

Complex 3 (0.168 mmol, 0.250 g) was suspended in acetone (35 cm³), then sodium acetylacetonate (1.68 mmol, 0.205 g) was added to this solution. The mixture was heated under reflux for 6 h; afterwards the solvent was reduced in volume under vacuum, and the product precipitated by the addition of water. The solid was recovered by filtration and washed with ethanol (15 cm³) and petroleum ether 60/90 (15 cm³). The yellow orange precipitate was purified on a silica column with CH₂Cl₂. Yield: 0.223 g (0.150 mmol, 89%).

¹H-NMR δ_{H} (270 MHz, CDCl₃): 8.66 (2H, d, ⁴J_{HH}=2.1 Hz, H⁶), 7.85 (2H, dd, ³J_{HH}=8.5 Hz, ⁴J_{HH}=2.1 Hz, H⁴), 7.72 (2H, d ³J_{HH}=8.5 Hz, H³), 7.51 (4H, d, J=9.1 Hz, AA‘XX’), 7.46 (2H, d, ³J_{HH}=8.8 Hz, H⁹), 6.98 (4H, d, J=8.8 Hz, AA‘XX’), 6.39 (2H dd, ³J_{HH}=8.5 Hz, ⁴J_{HH}=2.4 Hz, H⁸), 5.83 (2H, d, ⁴J_{HH}=2.4 Hz, H⁷), 5.29 (1H, s, CO—CH—CO), 3.99 (4H, t, OCH₂), 3.64 (4H, m, OCH₂), 1.78 (6H, s, CO—CH₃), 1.46 (4H, m, CH₂), 1.25 (76H, broad m, CH₂), 0.87 (12H, m, CHA). Anal. calcd. for C₈₇H₁₂₇IrN₂O₆: C, 70.17; H, 8.60; N, 1.88%. Found: C, 69.94; H, 8.48; N, 1.87%.

### Example 3.2

### Ir-acac-4-chains

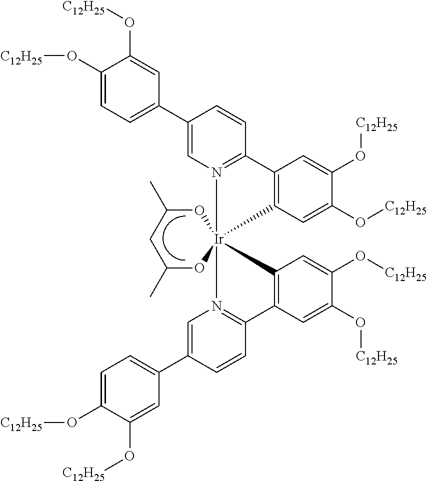

IrCl₃.3H₂O (0.26 mmol, 0.096 g) was added to a suspension of 2,5-di(3,4-didodecyloxyphenyl)pyridine (0.53 mmol, 0.515 g) in ethoxyethanol (40 cm³) and water (5 cm³); the mixture was stirred and heated under vigorous reflux for 12 h. The solution was cooled to room temperature and the yellow precipitate was collected by filtration. The precipitate was washed with water (10 cm³) and ethanol (10 cm³). The resulting dichloro-bridged dimer was purified on a silica column with CH₂Cl₂/petroleum ether (60/90) (6:4) to give wax orange solid. This was mixed with sodium acetylacetonate (0.54 mmol, 0.068 g) in chloroform-ethanol (4:1) mixture, and stirred under reflux for 4 h. Then solvent was removed, and the residue was passed through a silica column with CHCl₃ as eluent to give the title complex as a wax orange solid. Yield 0.35 g (0.16 mmol, 30%).

¹H-NMR δ_{H} (400 MHz, CDCl₃): 8.68 (2H, d, ³J_{HH}=1.8 Hz, H⁶), 7.82 (2H, dd, ³J_{HH}=8.8 Hz, ⁴J_{HH}=1.8 Hz, H⁴), 7.63 (2H, d, ³J_{HH}=8.8 Hz, H³), 7.13 (3H, m, Ar), 6.95 (1H, d, ³J_{HH}=8.4 Hz, Ar), 5.70 (2H, s, Ar), 5.21 (1H, s, COCHCO), 4.03 (8H, m, OCH₂), 3.88 (4H, m, OCH₂), 3.57 (4H, m, OCH₂), 1.83 (12H, m, CH₂), 1.70 (4H, m, CH₂), 1.48 (12H, m, CH₂), 1.23 (132H, broad m, CH₂), 0.87 (24H, m, CH₃). Anal. calcd. for C₁₃₅H₂₂₃IrN₂O₁₀: C, 72.83; H, 10.10; N, 1.26%. Found: C, 72.31; H, 9.98; N, 1.30%.

### Example 3.3

### Ir-acac-6-chains

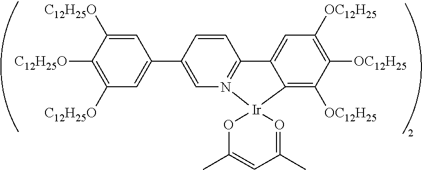

IrCl₁.3H₂O (0.19 mmol, 0.07) was added to a solution of 2,5-di(3,4,5-tridodecyloxyphenyl)pyridine (0.37 mmol, 0.50 g) in ethoxyethanol (40 cm³) and water (5 cm³); the mixture was stirred and heated under vigorous reflux for 12 h. The solution was cooled to room temperature and the yellow precipitate was collected by filtration. The precipitate was washed with water (10 cm³) and ethanol (10 cm³). The corresponding dichloro-bridged dimer was purified on a silica column with CH₂Cl₂/petroleum ether (60/90) (6:4) to give wax orange solid. This was mixed with sodium acetylacetonate (0.54 mmol, 0068 g) in chloroform-ethanol (4:1) mixture, and stirred under reflux for 4 h. Then solvent was removed, and the residue was passed through a silica column with CHCl₃ as eluent to give the title complex as a wax red solid. Yield 0.20 g (0.066 mmol, 35%).

¹H-NMR δ_{H} (400 MHz, CDCl₃): 8.52 (2H, d, ³J_{HH}=1.8 Hz, H⁶), 7.74 (2H, dd, ³J_{HH}=8.8 Hz, ⁴J_{HH}=1.8 Hz, H⁴), 7.63 (211, d, ³J_{HH}=8.8 Hz, H³), 7.03 (2H, s, Ar), 6.69 (4H, s, Ar), 5.11 (1H, s, COCHCO), 3.91 (24H, m, OCH₂), 3.22 (2H, m, CH₂), 2.49 (2H, m, CH₂), 1.74 (20H, m, CH₂), 1.52 (24H, m, CH₂), 1.22 (192H, broad m, CH₂), 0.85 (36H, m, CH₃). Anal. calcd. for C₁₈₃H₃₂₁IrN₂O₁₄: C, 74.11; H, 10.91; N, 0.94%. Found: C, 73.79; H, 10.91; N, 1.02%.

### Example 3.4

### Ir(L2)acac

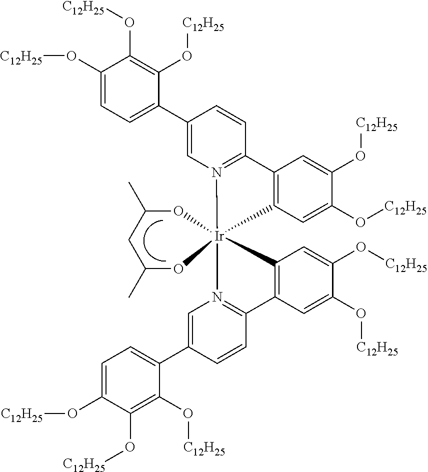

Prepared according to the method analogous to that of Example 3.3

¹H NMR δ_{H} (400 MHz, CDCl₃): 8.69 (2H, d, ⁴J_{HH}=−2.1 Hz, H⁶), 7.88 (21-1, dd, ³J_{HH}=8.5 Hz, ⁴J_{HH}=2.1 Hz, H⁴) 7.61 (2H, d, ³J_{HH}=8.5 Hz, H³), 7.11 (2H, s, Ar), 7.01 (2H, s, ³J_{HH}=8.5 Hz, Ar), 6.71 (2H, d, ³H_{HH}=8.5 Hz, Ar), 5.68 (2H, s, Ar), 5.21 (1H, s, COCHCO), 4.03 (8H, t, OCH2), 3.86 (8H, t, OCH2), 3.55 (4H, m, OCH2), 1.80 (18H, m, —COCH3+CH2), 1.54 (24H, m, CH2), 1.25 (164H, m, CH2), 0.88 (15H, m, Me).

### Example 3.5

### Ir(L3)acac

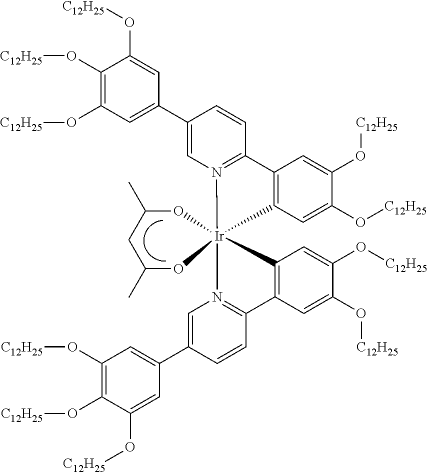

Prepared according to the method analogous to that of Example 3.3

¹H NMR δ_{H} (400 MHz, CDCl₃): 8.68 (2H, d, ⁴J_{HH}=2.1 Hz, H⁶), 7.81 (2H, dd, ³H_{HH}=8.5 Hz, ⁴J_{HH}=2.1 Hz, H⁴), 7.613 (2H, d, ³J_{HH}=8.5 Hz, H³), 7.11 (1H, s, Ar), 6.76 (4H, s, Ar), 5.69 (2H, s, Ar), 5.22 (1H, s, COCHCO), 4.00 (12H, m, OCH2), 3.88 (4H, t, OCH2), 3.55 (4H, m, OCH2), 1.76 (26H, m, —COCH3+CH2), 1.47 (20H, m, CH2) 1.24 (160H, m, CH2) 0.88 (15H, m, Me).

### Example 3.6

### NO₃—Ir

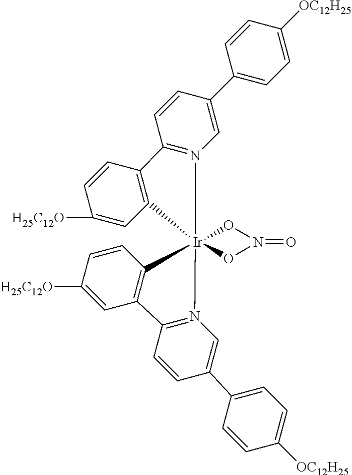

Complex of example 2.1 (0.049 mmol, 0.140 g) was dissolved in acetonitrile (25 cm³) and AgNO₃ (0.10 mmol 0.017 g) was added to this solution. The mixture was stirred at room temperature for 7 h and after this time was heated under reflux overnight. The product was precipitated by the addition of water, filtered and washed with methanol (20 cm³). Yield: 0.053 g (0.036 mmol, 74%)

¹H-NMR δ_{H} (270 Mhz, CDCl₃): 8.85 (2H, d, ⁴J_{HH}=2.0 Hz, H⁶), 7.96 (2H, dd, ³J_{HH}=8.6 Hz, ⁴J_{HH}=2.1 Hz, H⁴), 7.78 (2H, d=8.5 Hz, H³), 7.53 (4H, d, J=8.6 Hz, AA‘XX’), 7.46 (2H, d, ³J_{HH}=8.6 Hz, H⁹), 6.99 (4H, d, J=8.5 Hz, AA‘XX’), 6.44 (2H, dd, ³J_{HH}=8.6 Hz, ⁴J_{HH}2.5 Hz, H⁸), 5.65 (2H, d, ⁴J_{HH}=2.3 Hz, H⁷), 3.99 (4H, t, OCH₂), 3.65 (4H, m, OCH₂), 1.79 (4H, m, CH₂), 1.25 (76H, broad m, CH₂), 0.87 (12H, m, CH₃).

### 4. Dimeric Ir complexes

### Example 4.1a

### (Ir(L2)₂)₂tae—isomer 1

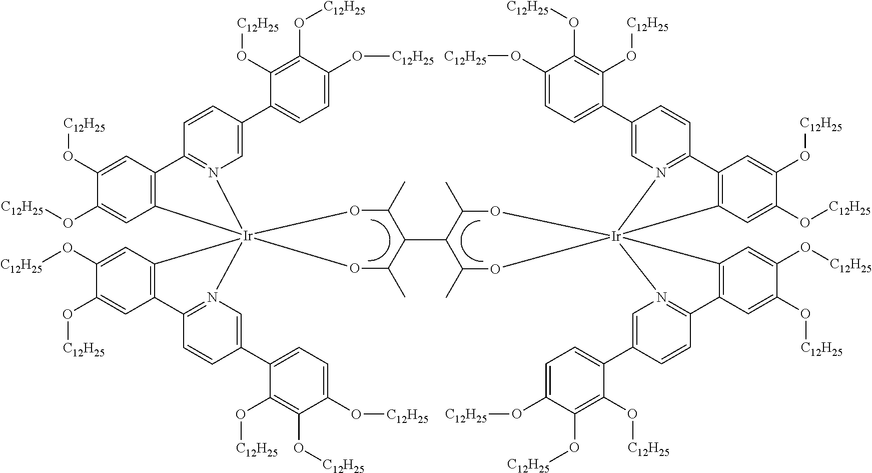

LC: Cr 79 Col_{H} 126 Iso

and

### Example 4.1b

### (Ir(L2)₂)₂tae—isomer 2

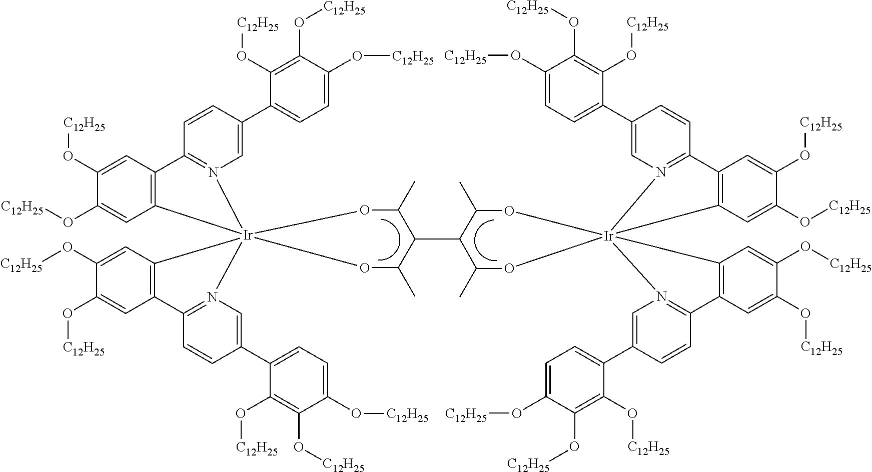

LC: Cr 63 Col_{H} 95 Iso

IrCl₃.3H₂O (0.11 mmol, 0.04 g) was added to a solution of 2-(3,4-didodecyloxyphenyl)-5-(2,3,4-tridodecyloxyphenyl)pyridine (0.22 mmol, 0.25 g) in ethoxyethanol (30 cm³) and water (3 cm³); the mixture was stirred and heated under vigorous reflux for 12 h. The solution was cooled to room temperature and the yellow precipitate was collected by filtration. The precipitate was washed with water (10 cm³) and ethanol (10 cm³). This was mixed with 1,1,2,2-tetraacetylethane (tae) (0.054 mmol, 0.011 g) and anhydrous potassium carbonate (0.015 mmol, 0.011 g) in chloroform-ethanol (2:1) mixture, and stirred under reflux for 4 h. Then solvent was removed, and two isomers, complexes 4.1a and 4.1b, were isolated by column chromatography on silica with CHCl₃ as eluent. Complex 4.1a has Rf=0.55 and 4.1b has Rf=0.50. Yield of each isomer is 0.10 g (0.019 mmol, 36%).

4.1a ¹H-NMR δ_{H} (400 MHz, CDCl₃): 8.58 (4H, d, ³J_{HH}=1.8 Hz, H⁶), 7.88 (4H, dd, ³J_{HH}=8.8 Hz, ⁴J_{HH}=1.8 Hz, H⁴), 7.58 (4H, d, ³J_{HH}=8.8 Hz, H³), 7.11 (4H, s, Ar), 6.80 (4H, d, ³J_{HH}=9.0 Hz, Ar), 6.53 (4H, d, ³J_{HH}=9.0 Hz, Ar), 5.68 (4H, s, Ar), 3.56-3.91 (40H, m, OCH₂), 1.71 (24H, m, CH₂), 1.52 (12H, m, COCH₂), 1.52-1.40 (16H, m CH₂), 1.21-1.36 (360H, m, CH₂), 0.86 (60H, m, CH₃). Anal. calcd. for C₃₁₈H₅₄₄Ir₂N₄O₂₄: C, 73.56; H, 10.56; N, 1.08%. Found: C, 73.71; H, 10.51; N, 1.02%.

4.1b. ¹H-NMR δ_{H} (400 MHz, CDCl₃): 8.55 (4H, d, ³J_{HH}=1.8 Hz, H⁶), 7.91 (4H, dd, ³J_{HH}=8.8 Hz, ⁴J_{HH}=1.8 Hz, H⁴), 7.56 (4H, d, ³J_{HH}=8.8 Hz, H³), 7.10 (4H, s, Ar), 6.81 (4H, d, ³J_{HH}=9.0 Hz, Ar), 6.50 (4H, d, ³J_{HH}=9.0 Hz, Ar), 5.71 (4H, s, Ar), 3.48-3.91 (40H, m, OCH₂), 1.68-1.79 (24H, m, CH₂), 1.48 (12H, m, COCH₃), 1.48-1.37 (16H, m, CH₂), 1.05-1.35 (360H, m, CH₂), 0.86 (60H, m, CH₃). Anal. calcd. for C₃₁₈H₅₄₄Ir₂N₄O₂₄: C, 73.56; H, 10.56; N, 1.08%. Found: C, 73.51; H, 10.53; N, 1.03%.

### Example 4.2

### (Ir(L1)₂)₂tae mixture of isomers

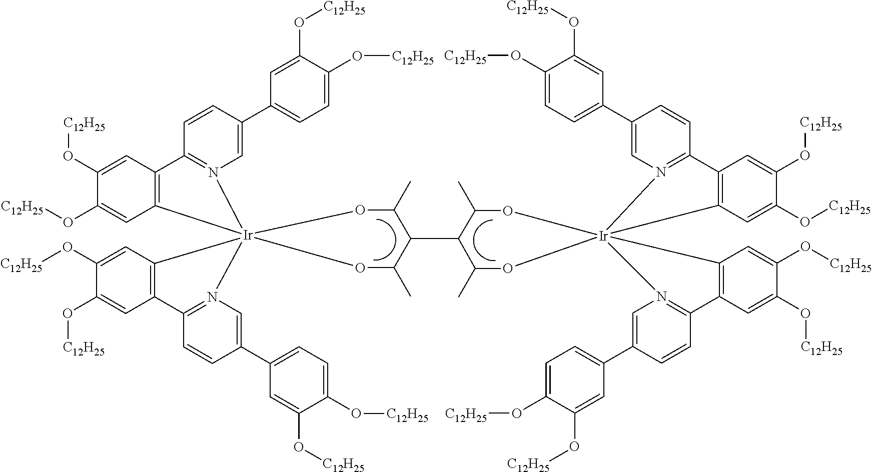

LC: Cr 74 Col_{H} 131 Iso

IrCl₃.3H₂O (0.21 mmol, 0.08 g) was added to a solution of 2,5-di(3,4-didodecyloxyphenyl)pyridine (0.41 mmol, 0.40 g) in ethoxyethanol (40 cm³) and water (5 cm³); the mixture was stirred and heated under vigorous reflux for 12 h. The solution was cooled to room temperature and the yellow precipitate was collected by filtration. The precipitate was washed with water (10 cm³) and ethanol (10 cm³). This was mixed with 1,1,2,2-tetaacetylethane (tae) (0.10 mmol, 0.021 g) and anhydrous potassium carbonate (0.06 mmol, 0.040 g) in chloroform-ethanol (2:1) mixture, and stirred under reflux for 4 h. Then solvent was removed and complex 4.2 was isolated by column chromatography on silica with CHCl₃ as a wax solid. Yield 0.25 g (0.056 mmol, 54%).

4.2. ¹H-NMR δ_{H} (400 MHz, CDCl₃): 8.61 (4H, d, ³J_{HH}=1.8 Hz, H⁶), 7.76 (4H, dd, ³J_{HH}=8.8 Hz, ⁴J_{HH}=1.8 Hz, H⁴), 7.63 (4H, d, ³J_{HH}=8.8 Hz, H³), 7.11 (4H, s, Ar), 6.94 (8H, m, Ar), 6.79 (4H, d, ³J_{HH}=9.0 Hz, Ar), 5.68 (4H, s, Ar), 3.79-3.94 (24H, m, OCH₂), 3.57 (8H, m, OCH₂), 1.81-1.68 (32H, m, CH₂), 1.51-1.01 (300H, m, CH₂+COCH₃), 0.86 (48H, m, CH₃). Anal. calcd. for C₂₇₀H₄₄8Ir₇N₄O₂₀: C, 72.79; H, 10.14; N, 1.26%. Found: C, 72.45; H, 10.10; N, 1.25%.

### Example 4.3

### (Ir(L2)₂)₂Cl

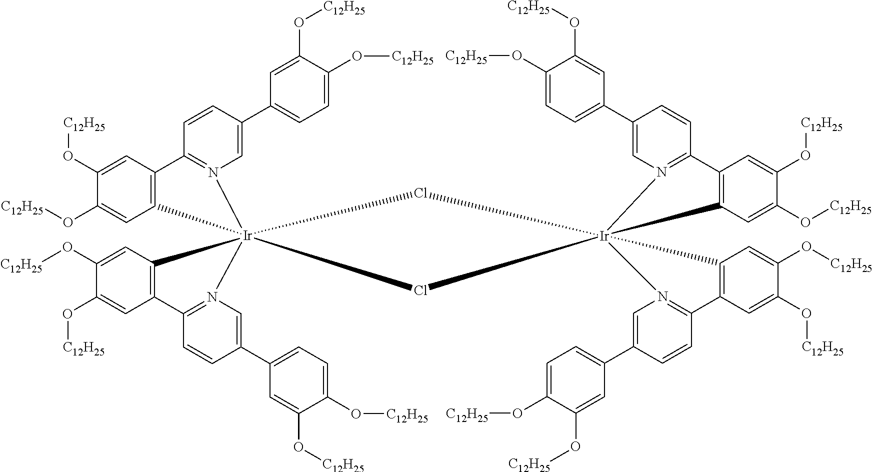

LC: Cr 43 LC 51 iso

IrCl₃.3H₂O (0.27 mmol, 0.096 g) was added to a solution of 22,5-di(3,4-didodecyloxyphenyl)pyridine (0.53 mmol, 0.515 g) in ethoxyethanol (20 cm³) and water (5 cm³); the mixture was stirred and heated under vigorous reflux for 12 h. The solution was cooled to room temperature and the yellow precipitate was collected by filtration. The precipitate was washed with water (10 cm³) and ethanol (10 cm³). The product 1.3 was purified by column chromatography on silica with CH₂Cl₂. Yield 0.25 g (0.06 mmol, 43%).

4.3 ¹H-NMR δ_{H} (400 MHz, CDCl₃): 9.58 (4H, d, ³J_{HH}=1.8 Hz, H⁶), 7.31 (4H, d, ³J_{HH}=8.8 Hz, H³), 7.24 (4H, dd, covered by solvent signal, H⁴), 6.97 (4H, s, Ar), 6.81 (4H, d, ³J_{HH}=8.3 Hz, Ar), 6.66 (4H, d, ³J_{HH}=8.3 Hz, Ar), 6.52 (4H, s, Ar), 5.38 (4H, s, Ar), 4.06 (8H, m, OCH₂), 3.81 (16H, m, OCH₂), 3.31 (8H, m, OCH₂), 1.91-1.65 (24H, m, CH₂), 1.51-0.98 (300H, broad m, CH₂), 0.85 (48H, m, CH₃). Anal. calcd. for C₂₆₀H₄₃₆Cl₂Ir₂N₄O₁₆: C, 72.13; H, 10.15; N, 1.30%. Found: C, 72.45; H, 10.17; N, 1.30%.

### Example 4.4

### (Ir(L2)₂)₂Cl

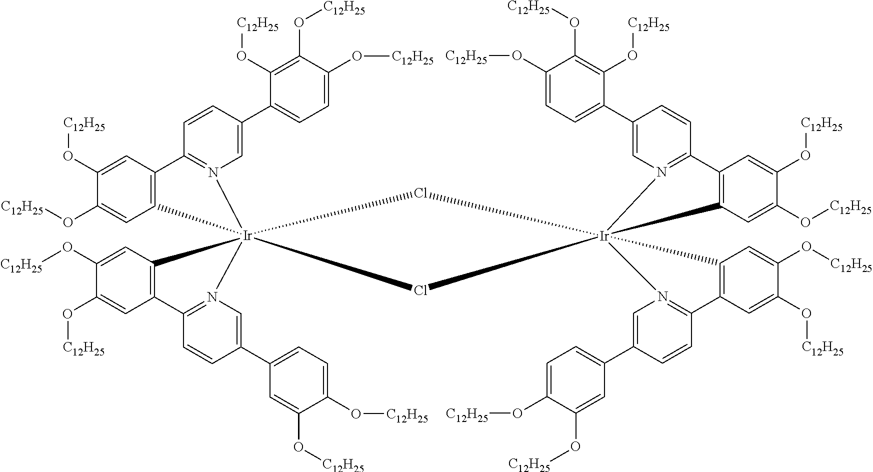

LC: Cr 50 LC 75 Iso

IrCl₃.3H₂O (0.10 mmol, 0.035 g) was added to a solution of 2-(3,4,-didodecyloxyphenyl)-5-(2,3,4-tridodecyloxyphenyl)pyridine (0.22 mmol, 0.25 g) in ethoxyethanol (20 cm³) and water (5 cm³); the mixture was stirred and heated under vigorous reflux for 12 h. The solution was cooled to room temperature and the yellow precipitate was collected by filtration. The precipitate was washed with water (10 cm³) and ethanol (10 cm³). The product 4.4 was purified on a silica column with CH₂Cl₂/petroleum ether (60/90) (6:4). Yield 0.20 g (0.039 mmol, 74%).

4.4 ¹H-NMR δ_{H} (400 MHz, CDCl₃): 9.59 (4H, d, ³J_{HH}=1.8 Hz, H⁶), 7.36 (4H, d, ³J_{HH}=8.8 Hz, H³), 7.25 (4H, dd, covered by solvent signal, H⁴), 6.94 (8H, s, Ar), 6.19 (4H, s, Ar), 5.31 (4H, s, Ar), 3.97 (8H, m, OCH₂), 3.80 (24H, m, OCH₂), 3.25 (8H, m, OCH₂), 1.74 (32H, m, CH₂), 1.22 (368H, broad m, CH₂), 0.85 (60H, m, CH₃) Anal. calcd. for C₃₀₈H₅₂₈Cl₂Ir₂N₄O₂₀: C, 73.07; H, 10.51; N, 1.11%. Found: C, 73.15; H, 10.47; N, 1.18%.

1. A non-planar iridium-ligand complex with accessible triplet states and a molecular structure that confers liquid-crystal like properties.

2. A non-planar iridium-ligand complex according to claim 1 wherein the molecular structure comprises a liquid crystal.

3. A non-planar iridium-ligand complex according to claim 1 wherein the molecular structure comprises a liquid crystal.

4. A non-planar iridium-ligand complex according to claim 1 wherein the complex may comprise three or four ligands.

5. A non-planar iridium-ligand complex according to claim 1 wherein the first and second ligands each comprise a pair of identical C,N bidentate ligands.

6. A non-planar iridium-ligand complex according to claim 1 wherein the complex comprises a pair of identical C,N bidentate ligands and either two other monodentate ligands or a further single bidentate ligand.

7. A non-planar iridium-ligand complex according to claim 1 wherein the C,N donor ligand is based on a 2,5-diphenylpyridine moiety of the general formula I: 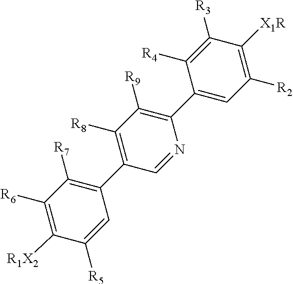
in which
(A) X₁ and X₂ are each a bond;
R is hydrogen, alkyl C1 to 30 or alkoxy C1 to 30;
R², R³ and R⁴ are each hydrogen;
R¹, R⁵, R⁶ and R⁷, which may be the same or different, are each hydrogen or alkoxy C1 to 30;
R⁸ and R⁹, which may be the same or different, are each hydrogen or R⁸ and R⁹ together form a 5- or 6-membered carbocyclic ring or a heterocyclic ring;
(B) X₁ and X₂ are each a bond;
R is hydrogen, alkyl C1 to 30 or alkoxy C1 to 30;
R², R³ and R⁴ are each hydrogen;
R¹ is alkyl C1 to 30 or alkoxy C1 to 30;
R⁵, R⁶ and R⁷ are each hydrogen;
R⁸ and R⁹, which may be the same or different, are each hydrogen or R⁸ and R⁹ together form a 5- or 6-membered carbocyclic ring or a heterocyclic ring;
(C) X₁ and X₂ are each a bond;
R¹ is hydrogen, alkyl C1 to 30 or alkoxy C1 to 30;
R⁵, R⁶ and R⁷, are each hydrogen;
R, R², R³ and R⁴, which may be the same or different, are each hydrogen or alkoxy C1 to 30;
R⁸ and R⁹, which may be the same or different, are each hydrogen or R⁸ and R⁹ together form a 5- or 6-membered carbocyclic ring or a heterocyclic ring;
(D) X₁ and X₂ are each a bond;
one of R, R², R³ and R⁴ is alkoxy C1 to 30 and the remainder, which may be the same or different, are each hydrogen or alkoxy C1 to 30;
one of R¹, R⁵, R⁶ and R⁷ is alkoxy C1 to 30 and the remainder, which may be the same or different are each hydrogen or alkoxy C1 to 30;
provided that at least three of R, R¹, R², R³, R⁴, R⁵, R⁶ and R⁷ represents alkoxy C1 to 30; and
R⁸ and R⁹, which may be the same or different, are each hydrogen or R⁸ and R⁹ together form a 5- or 6-membered carbocyclic ring or a heterocyclic ring;
provided that when the third ligand is acac and each of R, R¹, R², R³, R⁴, R⁵, R⁶ and R⁷ are hydrogen then —X₁R and —X₂R¹ do not both represent hydrogen, ethyl, methoxy or ethoxy.

8. A non-planar iridium-ligand complex according to claim 7 wherein the C,N donor ligand comprises a compound of formulae 1a-1n:

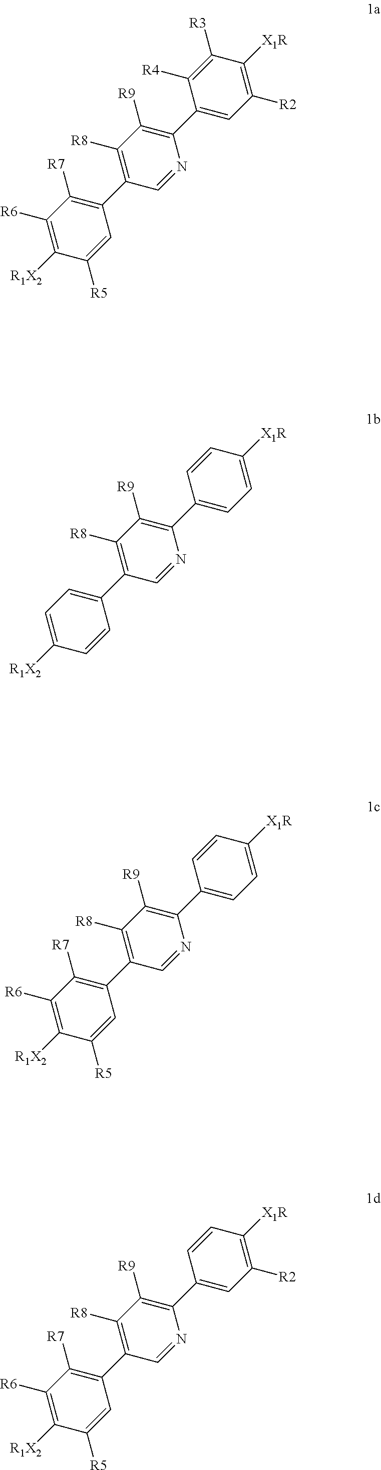

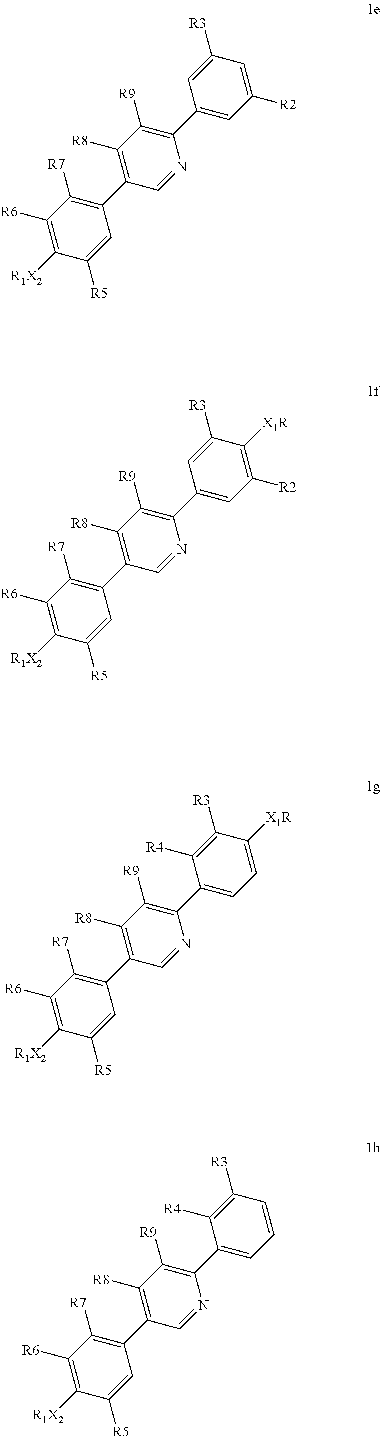

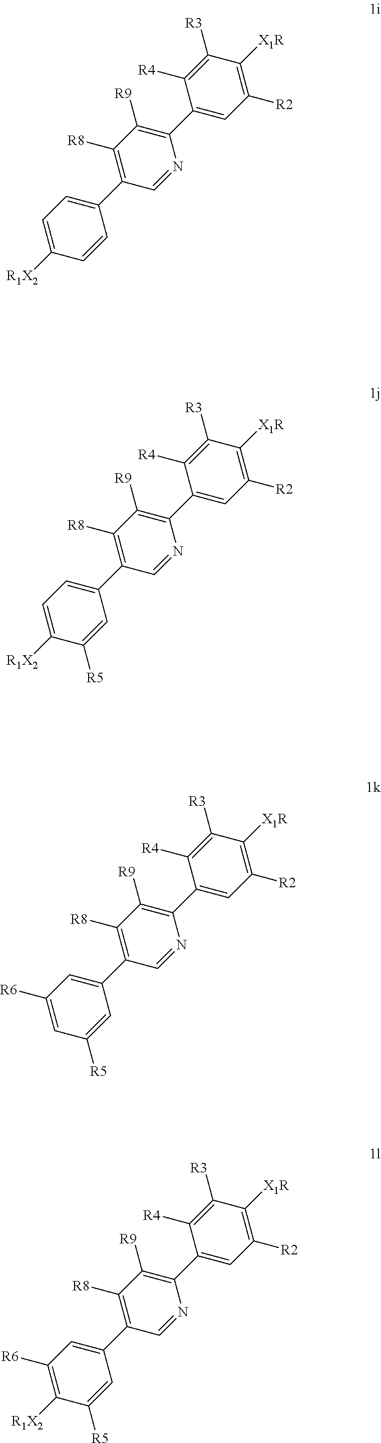

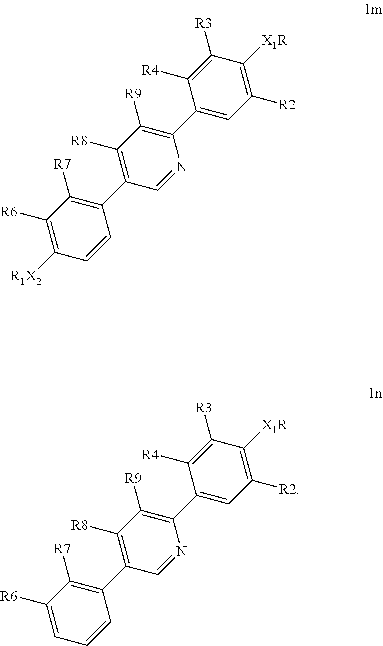

9. A non-planar iridium-ligand complex according to claim 8 wherein the complex comprises at least one ligand comprising a compound of formula I in which R⁸ and R⁹ are both hydrogen.

10. A non-planar iridium-ligand complex according to claim 8 wherein the complex comprises at least one ligand comprising a compound of formula I in which R⁸ and R⁹ together form a 5- or 6-membered carbocyclic ring or a heterocyclic ring.

11. A non-planar iridium-ligand complex according to claim 1 wherein the third and fourth ligand, which may be the same or different, is selected from the group consisting of one or more of halogen, a sulfoxide, carbon monoxide, halogen, or a simple monodentate anionic ligand or the third and fourth ligand together are a diketone or a tetraketone.

12. A non-planar iridium-ligand complex according to claim 1 wherein third and fourth ligands, which may be the same or different, are each selected from the group consisting of one or more of halogen, dimethyl sulfoxide (DMSO), carbon monoxide (CO), a single bidentate O,O donor ligand.

13. A non-planar iridium-ligand complex according to claim 1 wherein third and fourth ligands are each monodentate.

14. A non-planar iridium-ligand complex according to claim 1 wherein the third and fourth ligands together comprise a single bidentate O,O donor ligand.

15-18. (canceled)

19. A non-planar iridium-ligand complex according to claim 1 wherein the third ligand comprises a tetraketone, such that the complex is of the general formula IV; 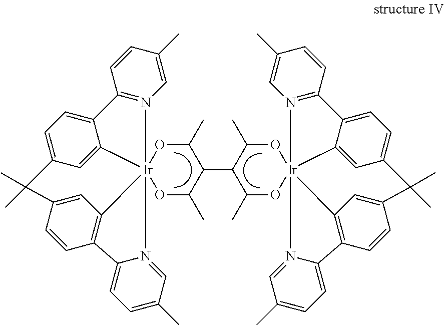
and all stereoisomers thereof.

20. A non-planar iridium-ligand complex according to claim 1 wherein the complex is of formula V; 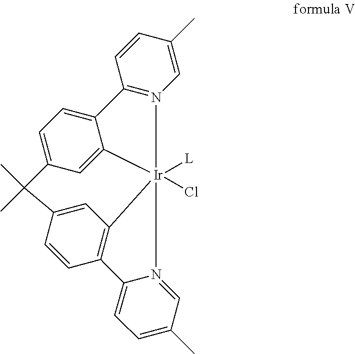
in which the C,N pairs each represent a bidentate ligand, which may be the same or different; and
L represents a ligand selected from the group consisting of, dimethyl sulfoxide (DMSO) and carbon monoxide (CO); and all stereoisomers thereof.

21. A non-planar iridium-ligand complex according to claim 1 wherein the complex is of the generic formula VI; 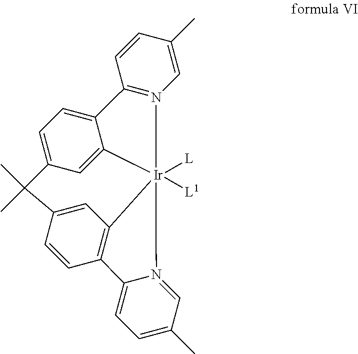
in which the C,N pairs each represent a bidentate ligand, and one of L and L¹ represents a neutral monodentate ligand and the other represents an anionic monodentate ligand or L and L¹ together represent a monoanionic bidentate ligand; and all stereoisomers thereof.

22. A non-planar iridium-ligand complex according to claim 1 wherein the complex is of the generic formula VII or VIII; 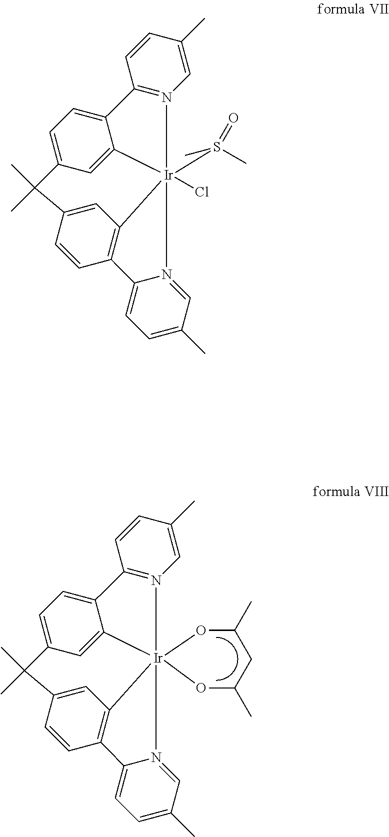
and all stereoisomers thereof.

23-26. (canceled)

27. An iridium ligand complex according to claim 1 wherein the complex is described in examples 2 to 4 herein.

28. A C,N donor ligand of the general formula I: 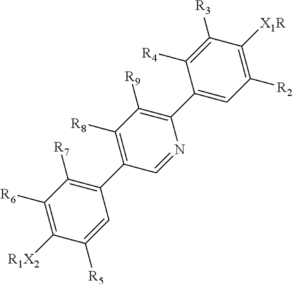
in which
(A) X₁ and X₂ are each a bond;
R is hydrogen, alkyl C1 to 30 or alkoxy C1 to 30;
R², R³ and R⁴ are each hydrogen;
R¹, R⁵, R⁶ and R⁷, which may be the same or different, are each hydrogen or alkoxy C1 to 30;
R⁸ and R⁹, which may be the same or different, are each hydrogen or R⁸ and R⁹ together form a 5- or 6-membered carbocyclic ring or a heterocyclic ring;
(B) X₁ and X₂ are each a bond;
R is hydrogen, alkyl C1 to 30 or alkoxy C1 to 30;
R², R³ and R⁴ are each hydrogen;
R¹ is alkyl C1 to 30 or alkoxy C1 to 30;
R⁵, R⁶ and R⁷ are each hydrogen;
R⁸ and R⁹, which may be the same or different, are each hydrogen or R⁸ and R⁹ together form a 5- or 6-membered carbocyclic ring or a heterocyclic ring;
(C) X₁ and X₂ are each a bond;
R¹ is hydrogen, alkyl C1 to 30 or alkoxy C1 to 30;
R⁵, R⁶ and R⁷, are each hydrogen;
R, R², R³ and R⁴, which may be the same or different, are each hydrogen or alkoxy C1 to 30;
R⁸ and R⁹, which may be the same or different, are each hydrogen or R⁸ and R⁹ together form a 5- or 6-membered carbocyclic ring or a heterocyclic ring;
(D) X₁ and X₂ are each a bond;
one of R, R², R³ and R⁴ is alkoxy C1 to 30 and the remainder, which may be the same or different, are each hydrogen or alkoxy C1 to 30;
one of R¹, R⁵, R⁶ and R⁷ is alkoxy C1 to 30 and the remainder, which may be the same or different are each hydrogen or alkoxy C1 to 30;
provided that at least three of R, R¹, R², R³, R⁴, R⁵, R⁶ and R⁷ represents alkoxy C1 to 30; and
R⁸ and R⁹, which may be the same or different, are each hydrogen or R⁸ and R⁹ together form a 5- or 6-membered carbocyclic ring or a heterocyclic ring;
provided that at least one of R², R³, R⁴, R⁵, R⁶ and R⁷ is alkyl C1 to 30 or alkoxy C1 to 30.

29. (canceled)

30. A material comprising a non-planar iridium-ligand complex claim 1 wherein the complex comprises at least two types of ligands one of which comprises a bidentate donor ligand wherein the complex has accessible triplet states and a molecular structure that confers liquid-crystal like properties.

31-32. (canceled)
